(19) United States
(12) Patent Application Publication
(10) Pub. No.: US 2022/0009812 A1
(43) Pub. Date: Jan. 13, 2022

(54) METHOD OF TREATING A LIQUID INCLUDING AN ORGANOFLUORINE

(71) Applicant: HYDRUS TECHNOLOGY PTY. LTD., Brisbane (AU)

(72) Inventors: Brook Douglas HILL, Glass House Mountains (AU); Wiley PARKER, Conroe, TX (US); Jiasheng CAO, Houston, TX (US); David Victor CAM, Brisbane (AU); John Frederick ELLERS, Brisbane (AU)

(73) Assignee: HYDRUS TECHNOLOGY PTY. LTD., Brisbane (AU)

(21) Appl. No.: 17/294,302

(22) PCT Filed: Nov. 15, 2019
(86) PCT No.: PCT/AU2019/051263

§ 371 Date: May 14, 2021

(30) Foreign Application Priority Data
Nov. 16, 2018 (AU) 2018904387

(51) Int. Cl. C02F 9/00

(52) U.S. Cl. CPC C02F 9/00; C02F 1/5254

(57) ABSTRACT

The present invention relates to a method of treating a liquid including an organofluorine. The method includes electrochemically treating the liquid to produce a foam and an electrochemically treated liquid, wherein the foam includes the organofluorine and/or degradation products thereof; and separating the foam from the electrochemically treated liquid. This method may alleviate some of the problems associated with the presently available techniques for removing organofluorines from liquids.

### TECHNICAL FIELD

The present invention relates to, inter alia, a method of treating a liquid including an organofluorine, especially a method of separating and/or degrading an organofluorine from a liquid. The organofluorines may be especially fluorinated surfactants, or poly- or perfluoroalkyl compounds.

### BACKGROUND ART

It will be clearly understood that, if a prior art publication is referred to herein, this reference does not constitute an admission that the publication forms part of the common general knowledge in the art in Australia or in any other country.

Organofluorines (compounds which include a C—F bond), and especially alkylfluorines, are produced industrially for a wide range of applications, including as surfactants, polymers (such as Teflon™), firefighting foams, and in medicinal and agricultural products. However, alkyl C—F bonds are very strong, and are typically extremely stable, being resistant to hydrolysis, photolysis, microbial degradation and metabolism by vertebrates. Whilst fluorine is very electronegative, when a carbon atom is substituted by many fluorine atoms (such as in perfluoroalkyl compounds) the dipole moment of each C—F bond can cancel each other, and can result in a relatively non-polar (and non-reactive) compound. Furthermore, the fluorine in an alkyl C—F bond can sterically shield the carbon atom to which it is attached, and the three pairs of non-bonding electrons in fluorine's outer electronic shell can also protect the C—F bond, further improving the stability of alkylfluorines. C—F bonds are not common in nature, and consequently there are few biological pathways to break down alkyl C—F bonds. Consequently, alkylfluorines are often very stable and have a half-life spanning decades. It can be very difficult to degrade such alkylfluorines, or to separate them from liquids including water.

Due to extensive use, organofluorines, and especially per- and polyfluoroalkyl substances (PFASs), are frequently found in groundwater, landfill leachates, and industrial wastes. PFASs have accordingly attracted increasing attention as emerging contaminants of global concern.

When a charged moiety, such as a carboxyl or sulfonyl group, is attached to a perfluorinated alkyl group, the resultant molecule can have surfactant properties. Detergents, or surfactants, have the property of being able to reduce the surface tension of water at the air-water interface, causing a water droplet to spread on a surface. By this action they can emulsify hydrocarbons, oils and greases forming micelles to form a milky colloidal suspension in water.

Organofluorine surfactants are distinguished from hydrocarbon surfactants in having a hydrophobic chain which is also oleophobic (oil-hating) enabling them to film-form at hydrocarbon-water interfaces. This is achieved by having at least one hydrogen atom in the hydrophobic segment replaced by fluorine, thereby lowering the water surface tension below the limit reached by conventional hydrocarbon-type surfactants. Organofluorine surfactants, and especially perfluorinated surfactants, are a group of contaminants of particular concern.

The acronym for foams derived from fluorosurfactants is AFFF (aqueous film-forming foam). These foams have very high chemical, thermal and storage stability to offset the much greater expense of fluorination. They are extremely resistant to chemical attack as well as being stable to heat, acids, alkalis and reducing and oxidizing agents. This extraordinary thermal and chemical stability leads to their special uses, for example in fire-fighting foams to extinguish fires at high-temperature. They are also used in pesticides, cosmetics, adhesives, greases and lubricants where they exhibit unique properties including persistence against biochemical attack. The practical import is that essentially all of the fluorosurfactant chemicals produce long-lived fluorinated degradation products which are both extremely chemically persistent and becoming more widely dispersed throughout the environment.

A common organofluorine used in AFFF to fight fires is perfluorooctane sulfonate (PFOS), which reduces the surface tension of water allowing an aqueous film to spread over a flammable liquid and effectively provide a vapor seal during fire fighting operations. However the resulting foams are biologically persistent and refractory in nature and have been detected in wastewater and landfill leachate virtually unchanged from their original composition. Conventional wastewater treatments have been shown to be unable to either modify or degrade the more persistent perfluorinated compound, resulting in their passage through conventional wastewater systems essentially unchanged. The discharge of these compounds to the freshwater and marine environment results in undesirable biomagnification and accumulation in some species, ultimately impacting food chains in a significant and harmful way. Fluorinated surfactants also become adsorbed to sewage sludge and hence disposal of sludge in either landfills or re-use on agricultural land leads to their remobilization into groundwater and the food chain respectively.

For example, a 2016 study covering two-thirds of drinking water supplies in the United States found levels of fluorosurfactants above safe drinking water guidelines in 194 out of 4,864 water supplies in thirty three (33) U.S. states, with thirteen (13) states accounting for almost 75% of the detections (Hu, X. C. et al (2016) Environ. Sci. Technol. Lett., 3(10), 344-350). Firefighting foam was singled out as a major contributor. Sixty-six of the public water supplies examined, serving six million people, had at least one water sample that measured at or above the EPA safety limit of 70 parts per trillion (ng/L) for two types of PFASs, perfluorooctanesulfonic acid (PFOS) and perfluorooctanoic acid (PFOA). Concentrations ranged as high as 349 ng/L for PFOA (Warminster, Pa.) and 1,800 ng/L for PFOS (Newark, Del.).

Discharge of effluents from municipal wastewater treatment plants is a primary route for the introduction of refractory and persistent organic contaminants into marine and freshwater aquatic environments. Earlier studies have reported the occurrence of perfluorinated compounds (PFCs) in effluents from wastewater treatment plants. Contamination profiles of these PFCs included perfluoroalkyl sulfonates (such as perfluorooctane sulfonate (PFOS), and perfluorohexane sulfonate (PFHxS)) and perfluoroalkyl carboxylates (such as perfluorooctanoate (PFOA), perfluorononanoate (PFNA), perfluorodecanoate (PFDA), perfluorododecanoate (PFDoDA), and perfluoroundecanoate (PFUnDA)). All were detected in samples collected at various stages of wastewater treatment during different seasons, with concentrations of some perfluorinated compounds, particularly perfluorooctanoate, slightly higher in effluent than in influent, suggesting that biodegradation of some precursors contributes to the increase in perfluorooctanoate concentrations in wastewater treatment processes.

Perfluorooctane sulfonic acid (PFOS) also results from the chemical or metabolic hydrolysis of some fluorosurfactants and can form salts with monovalent metallic cations, many of which appear to be resistant to further degradation under normally occurring environmental conditions. This leaves PFOS as the ultimate degradation product from many fluorochemicals and it will generally persist in that form. Unfortunately, PFOS is known to be both toxic, (affecting hormonal metabolism and reproduction in test species) and bio-accumulative (showing biomagnification in the food chain). PFOS is also so chemically stable that it is able to withstand hot nitric or sulphuric acid for 24 hours without decomposition.

Perfluorooctanoate (PFOA) is a similar surfactant widely associated with fluorocarbon manufacture and firefighting foams. The strength and characteristics of the carbon-fluorine bond insures that the molecule once formed is relatively inert and persists in the environment for long periods. The detrimental health effects of PFOA have been widely documented and there has been an increasing need to remove this chemical from ground water sources.

Accordingly, there is a need to develop technologies for removing organofluorines (and especially organofluorine surfactants) from liquids, and especially aqueous systems.

The most widespread currently adopted means of removal of fluorinated surfactants are ion exchange filters (IX) and activated carbon filtration (ACF). These methods require the use of expensive ion exchange resins and activated carbon both of which have very limited life before reaching saturation. However, they both have the potential to reduce the concentration of fluorinated surfactants in aqueous streams to low levels. Following saturation, these media are then removed and incinerated at high temperature to destroy the perfluorinated species.

There are numerous challenges to the approach outlined in the preceding paragraph. Firstly, the media are non-specific, since the adsorptive capacity of the media can be consumed by ubiquitous but commonly occurring ion species also present in the water column, particularly organic components in leachate. Secondly, the media are relatively expensive to procure and require regular replenishment as they approach saturation. Thirdly, in approaching saturation, the media become ineffective in removing the contaminant from the water (although the precise point at which this impedes their effectiveness is difficult not easy to determine). Fourthly, the media are used in sufficient quantity and volumes that consideration has to be given to the costs and availability of transport, drying and acceptable disposal or incineration services, the latter almost certainly requiring special air quality considerations.

Ultrasonication and short-wavelength UV irradiation has been used for decomposing hydrophobic perfluorochemicals (Sekiguchi K., et al. (2017) Ultrasonics Sonochemistry, 39, 87-92). However, this process required extensive cell residence times of up to 120 minutes to achieve complete removal.

Electrocoagulation-Flotation (ECF) methods have also been used to remove PFOA (for example, Yang et al. (2016) Emerging Contaminants, 2, 49-55). However, this paper promotes the use of ferric iron flocs as removal agents with long reaction times (30-45 minutes) to affect significant removal rates. Although not stated in this paper, it seems that the PFOA is adsorbing to the resulting ferric hydroxide flocculant which is discarded when saturated.

Other work by Schaefer, C. E. et al. (2015) Journal of Hazardous Materials, 295, 170-175) used a titanium/ruthenium mixed metal oxide (MMO) anode at varying current densities from 2.5 to 10.0 mA/cm². The effectiveness of these anode materials was also compared with more expensive anode materials such as boron doped diamond (BDD) and titanium/stannic oxide/bismuth. Although defluorination was observed for both PFOA and PFOS, the rate of treatment was extremely slow with cell residence times of up to 600 minutes (10 hrs) and shorter chain perfluoroalkyl acids were found to be resistant to degradation even at these extensive treatment times.

### SUMMARY OF INVENTION

There is a need to provide a method which at least partially overcomes at least one of the abovementioned disadvantages or which provides the consumer with a useful or commercial choice.

In a first aspect, the present invention provides a method of treating a liquid including an organofluorine, the method comprising:
electrochemically treating the liquid to thereby produce foam and an electrochemically treated liquid, wherein the foam includes the organofluorine and/or degradation products thereof; and
separating the foam from the electrochemically treated liquid.

As used herein, the term “treating”, “treatment” or the like means that the liquid is electrochemically treated; it does not mean that the organofluorine is chemically modified following the treatment. In one embodiment, the method of treating a liquid including an organofluorine is a method of separating an organofluorine from a liquid and/or a method of degrading an organofluorine in a liquid. As used herein, an organofluorine would be degraded when one or more covalent bonds in the organofluorine are broken. For example, if perfluorooctanoate (PFOA) is degraded it may be decarboxylated, a C—F bond may be broken (and the F may be optionally replaced with a different atom, such as a Cl), or a C—C bond may be broken (in which case a shorter chain organofluorine may be produced).

The invention of the first aspect takes advantage of the nature of electrochemical treatment systems and the characteristics of many organofluorines, to separate and/or degrade organofluorines. During electrochemical treatment a gas can be bubbled through the liquid, or alternatively the electrochemical treatment may be configured to produce gas bubbles (for example, hydrogen gas may be generated at the electrodes). The gas bubbling through the liquid interacts with the organofluorines present in the liquid and becomes entrained with the organofluorine, resulting in the production of a foam. The now buoyant foam including the organofluorine floats to the surface of the liquid, where it may then be collected to separate the organofluorine from the liquid.

Advantageously, while some organofluorines may be degraded due to the electrochemical treatment, the electrochemical treatment may be effective without degrading the organofluorine (and organofluorine degradation products may also produce foams in the electrochemical treatment). For example, for an organofluorine surfactant, the method takes advantage of the surfactant properties of the organofluorine to produce a foam in the electrochemical treatment and effect separation (the organofluorine surfactant stabilises the foam). Furthermore, some organofluorines may not produce a foam in the electrochemical treatment (either due to the characteristics of the organofluorine, or due to the conditions under which the electrochemical treatment is performed). However, foam-forming organofluorines may draw non-foaming organofluorines into the foam layer, thereby improving separation.

Some organofluorines or degradation products thereof may also not be drawn into the foam layer; instead floc may be produced during the electrochemical treatment which includes such organofluorines or degradation products thereof. After the electrochemical treatment such floc may settle out of the treated liquid where it may be separated (for example the floc may be drained from the treated liquid and the resulting contaminated sludge then passed through a screw press for subsequent disposal as an essentially dry cake).

For avoidance of doubt, the foam produced during electrochemical treatment may not include all organofluorine, but the foam would include at least a portion of the organofluorine from the liquid. The organofluorine may preferentially be part of the foam over the electrochemically treated liquid.

As used herein, the term “organofluorine” refers to substances or compounds that includes a carbon-fluorine bond. In some embodiments, an organofluorine includes a fluoroalkyl group, and may be an fluoroalkyl substance or compound. The “fluoroalkyl group” is an alkyl group (as defined below) which is substituted by at least one fluorine. The fluoroalkyl may be optionally substituted. The fluoroalkyl may be a polyfluoroalkyl or a perfluoroalkyl. In one embodiment, at least 10% of the carbon atoms in the substance or compound is substituted by a fluorine, especially at least 20%, at least 30%, at least 40%, at least 50%, at least 60%, at least 70%, at least 80% or at least 90% of the carbon atoms in the substance or compound (or organofluorine) is substituted by a fluorine atom. In one embodiment, all carbon atoms in the substance or compound are substituted by a fluorine.

In one embodiment, the organofluorine or fluoroalkyl group has a degree of fluorination of at least 10%, especially at least 20%, at least 30%, at least 40%, at least 50%, at least 60%, at least 70%, at least 80% or at least 90%. The organofluorine or fluoroalkyl group may have a degree of fluorination of 100%. As used herein, the term “degree of fluorination” refers to a percentage of the number of fluorine atoms covalently bonded to carbon atoms in the organofluorine, divided by the total number of sites at which a fluorine could be bonded to a carbon in the organofluorine (including sites where monoatoms are bonded (such as hydrogen and other halogens), but not including sites where functional groups including more than one atom are bonded (such as amino groups, nitro groups, sulfate groups, and other alkyl groups)). For example, perfluorooctanoate, and perfluorooctane sulphonamide both have a degree of fluorination of 100%. Trichlorofluoromethane would have a degree of fluorination of 25%, and 1,1,2-trichlorotrifluoroethane would have a degree of fluorination of 50%.

The organofluorine may include an ionic group. The ionic group may be an anionic group or a cationic group. The ionic group may be ionic at a pH of about 7. An anionic group (or a group that carries a negative charge) may include, for example, an acidic group. The anionic group may include, for example, a sulfate, a nitrate, a phosphate, or a carboxylate. A cationic group (or a group that carries a positive charge) may include, for example, basic group. The cationic group may include, for example, a nitrogen containing group such as an amine, an imine or a nitrogen-containing heterocycle (such as an indole, imidazole, purine or pyrimidine). Exemplary cycloalkyl groups may include cyclopropyl, cyclobutyl, cyclopentanyl, cyclohexanyl, cycloheptanyl, cyclooctanyl, decahydronaphthalyl, bicyclo[3.1.0]hexanyl, bicyclo[4.1.0]heptanyl, bicyclo[3.1.1]heptanyl, bicyclo[2.2.1]heptanyl, adamantanyl and spiranes such as spiro[4.5]decane.

As used herein the term “alkyl” refers to a straight chain, branched or cyclic saturated hydrocarbon group. The alkyl group may have from 1 to 24 carbon atoms, especially from 1 to 12 carbon atoms, more especially from 1 to 6 carbon atoms or from 7 to 12 carbon atoms. Where appropriate, the alkyl group may have a specified number of carbon atoms, for example, C₁₋₆alkyl which includes alkyl groups having 1, 2, 3, 4, 5 or 6 carbon atoms in a linear, branched or cyclic arrangement. Examples of suitable alkyl groups include, but are not limited to, methyl, ethyl, n-propyl, i-propyl, n-butyl, t-butyl, i-butyl, n-pentyl, 2-methylbutyl, 3-methylbutyl, 4-methylbutyl, n-hexyl, 2-methylpentyl, 3-methylpentyl, 4-methylpentyl, 5-methylpentyl, 2-ethylbutyl, 3-ethylbutyl, heptyl, octyl, nonyl, decyl, undecyl and dodecyl. The alkyl group may include 7, 8, 9, 10, 11 or 12 carbon atoms. The alkyl group may be a straight chain or branched alkyl group. The alkyl group may be a cycloalkyl group.

The organofluorine and/or the alkyl group may be optionally substituted, for example, with one or more of an alkyl (including C₁₋₆ alkyl), halo (including chloro, bromo or iodo), nitro, cyano, alkenyl, hydroxy, alkynyl, —O—R¹, sulfate, carboxyl, —CO—O—R¹, —O—CO—R¹, aryl, heterocyclyl, heteroaryl, —S—R¹, —SO₂NH₂, amino, —NH—R¹, —N—(R¹)₂ or a phosphate, wherein R¹ is selected from the group consisting of an alkyl, alkenyl, alkynyl, aryl, heteroaryl or heterocyclyl; wherein the alkyl, alkenyl, alkynyl, aryl, heteroaryl or heterocyclyl groups may be optionally substituted with one or more substituents selected from cyano, hydroxyl, nitro, halo, alkyl, haloalkyl, alkenyl, alkynyl or —O-alkyl groups.

As used herein, the term “alkenyl” refers to refers to a straight-chain, branched or cyclic hydrocarbon group having one or more double bonds between carbon atoms. The alkenyl group may have from 2 to 12 carbon atoms. Where appropriate, the alkenyl group may have a specified number of carbon atoms. For example, C₂-C₆ as in “C₂-C₆ alkenyl” includes groups having 2, 3, 4, 5 or 6 carbon atoms in a linear, branched or cyclic arrangement. Examples of suitable alkenyl groups include, but are not limited to, ethenyl, propenyl, isopropenyl, butenyl, butadienyl, pentenyl, pentadienyl, hexenyl, hexadienyl, heptenyl, octenyl, nonenyl, decenyl, undecenyl and dodecenyl.

As used herein, the term “alkynyl” refers to a straight-chain, branched or cyclic hydrocarbon group having one or more triple bonds between carbon atoms and having 2 to 12 carbon atoms. Where appropriate, the alkynyl group may have a specified number of carbon atoms. For example, C₂-C₆ as in “C₂-C₆ alkynyl” includes groups having 2, 3, 4, 5 or 6 carbon atoms in a linear, branched or cyclic arrangement. Examples of suitable alkynyl groups include, but are not limited to, ethynyl, propynyl, butynyl, pentynyl, hexynyl, octynyl, nonynyl, decynyl, undecynyl and dodecynyl.

As used herein, the term “aryl” refers to any stable, monocyclic, bicyclic or tricyclic carbon ring of up to 7 atoms in each ring, wherein at least one ring is aromatic. When more than one ring is present, the rings may be fused to one another. Examples of aryl groups include, but are not limited to, phenyl, naphthyl, tetrahydronaphthyl, indanyl, biphenyl, binaphthyl, anthracenyl, phenanthrenyl, phenalenyl and fluorenyl.

As used herein, the term “heterocyclyl” refers to a cycloalkyl or cycloalkenyl group in which one or more carbon atoms have been replaced by heteroatoms independently selected from N, S and O. For example, between 1 and 4 carbon atoms in each ring may be replaced by heteroatoms independently selected from N, S and O. The heterocyclic group may be monocyclic, bicyclic or tricyclic in which at least one ring is heterocyclic. When there are two or three rings, each ring is linked to one or more of the other rings by sharing one or more ring atoms forming a spirane or fused ring system. The heterocyclyl group may also include a carbonyl group attached to an unsaturated ring carbon, Examples of heterocyclyl groups may include tetrahydrofuranyl, tetrahydrothiophenyl, pyrrolidinyl, 2-pyrrolidonyl, pyrrolinyl, dithiolyl, 1,3-dioxolanyl, pyrazolinyl, imidazolinyl, imidazolidonyl, 1,4-dioxanyl, 1,3-dioxanyl, dioxinyl, piperidinyl, piperazinyl, morpholinyl, thiomorpholinyl, pyranyl, 1,4-dithiane, 1,3,5-trithiane, quinuclidine and tetrahydropyranyl.

As used herein, the term “heteroaryl” refers to a stable monocyclic, bicyclic or tricyclic ring of up to 7 atoms in each ring, wherein at least one ring is aromatic and at least one ring contains from 1 to 4 heteroatoms selected from the group consisting of O, N and S. When more than one ring is present the rings may be fused. The heteroaryl group may also include a carbonyl group attached to an unsaturated carbon in the ring system. Examples of heteroaryl groups include pyrrolyl, furanyl, thienyl, pyrazolyl, imidazolyl, pyridinyl, pyridazinyl, pyrimidinyl, indolyl, benzimidazolyl, benzopyranyl, quinolinyl, tetrahydroquinolinyl, isoquinolinyl, quinazolinonyl, and quinazolindionyl.

The organofluorine may be of formula (I):

R—Y Formula (I)

wherein R is a fluoroalkyl group, and wherein Y is an ionic group. The fluoroalkyl group may be optionally substituted. The fluoroalkyl group may be as defined above. The ionic group may be as defined above.

As used herein, the term “foam” relates to a gas entrained in another continuous phase. The foam may include gaseous bubbles of any suitable diameter. In one embodiment, the foam includes gaseous bubbles of a diameter (or the foam includes bubbles of an average diameter) of at least 300 μm; especially at least 400 μm, at least 500 μm, or at least 600 μm; more especially at least 700 μm or at least 800 μm.

As used herein, the term “floc” relates to a solid material initially dispersed in the liquid phase. For the avoidance of doubt, gaseous bubbles may be entrained in the floc resulting in a temporary flotation of the solid material. However, bubbles which nucleate on a dispersed solid are not a foam as the solid does not form a continuous boundary around the gas. The solid material may be formed, for example, by reaction between suspended metal oxide species (for example from the anode) and contaminants in the liquid.

The liquid may be any suitable liquid including an organofluorine. The liquid may be, for example, a groundwater, a landfill leachate, or an industrial wastes. For example, groundwater from airports and military installations may be contaminated with fire fighting foams which may require treatment. The liquid may be an aqueous liquid which includes an organofluorine.

The method may include the step of removing or depleting ammonia or ammonium from the liquid prior to the electrochemical treatment. Suitable ways of removing or depleting ammonia or ammonium from a liquid would be known to a skilled person. For example, air or steam stripping or chemical precipitation may be used. The step may include basifying the liquid, for example by adding a base to bring the pH of the liquid above 9, especially above 10, more especially above 11, most especially above 11.5. The basic liquid may be heated, for example to at least 30° C., especially at least 40° C., more especially at least 50° C., most especially at least 60° C. The heated liquid may be cooled. The basic liquid may be acidified, for example by adding an acid to bring the pH of the liquid below 11, especially below 10, more especially below 9 or below 8, most especially between about 5 to 9, or about 6 to 8, or to about 7.

In another example, the method may include the step of removing or depleting ammonia/ammonium by chemical precipitation. For example, a magnesium salt (such as magnesium chloride) and/or a phosphate salt (such as sodium phosphate) may be added to form a precipitate such as a magnesium ammonium phosphate precipitate (such as struvite). The precipitate may be relatively insoluble in water. The chemical precipitate may be settled and/or filtered from the liquid.

In some embodiments, removal or depletion of ammonia or ammonium may be advantageous to decrease or minimise the production of sulfonamides which may not separate into the foam.

The method may include the step of filtering the liquid prior to the electrochemical treatment. The step of filtering the liquid may remove large particulate solids from the fluid stream that could otherwise become lodged between the electrodes and disrupt the functioning of the electrochemical treatment apparatus.

The method may include the step of electrochemically treating the liquid using an electrochemical treatment apparatus. The electrochemical liquid treatment apparatus may include a treatment chamber including at least one inlet for entry of a liquid to be treated, and at least one outlet for exit of electrochemically treated liquid, and a plurality of electrodes positioned within the treatment chamber for electrochemical treatment of the liquid. The electrochemical liquid treatment apparatus may be as further described below.

The method may include the step of introducing a liquid to be treated into the apparatus. The method may include the step of applying a voltage to at least two of said plurality of electrodes to provide at least one cathode and at least one anode to thereby electrochemically treat the liquid. The method may include the step of removing electrochemically treated liquid from the apparatus.

The method may include the step of generating floc as the liquid is electrochemically treated. The method may include the step of removing floc from the apparatus. The method may also include the step of introducing at least one treatment agent into the apparatus, especially in which the treatment agent is a gas or an oxidant or reductant. The treatment agent may be as described below. The method may also include the step of applying a treatment enhancer to the treatment chamber. In a further embodiment, the method includes the step of reversing the polarity of the at least one cathode and the at least one anode during the electrochemical treatment.

The liquid may be electrochemically treated at any suitable temperature or pressure. However, the electrochemical treatment is especially performed at atmospheric temperature and pressure.

The electrodes used in the electrochemical treatment (or at least one of the electrodes used in the electrochemical treatment) may include, for example, iron, mild steel, stainless steel, titanium, aluminium alloy, or magnesium alloy compositions; especially mild carbon steel. However, more expensive electrodes such as mixed metal oxide (MMO) and boron doped diamond (BDD) anode compositions may be used.

During the electrochemical treatment, iron in the electrodes (if present) may be released into the liquid from the anode as Fe²⁺ or Fe³⁺. Meanwhile at the cathode water may break down into hydrogen gas and hydroxyl ions.

As hydrogen gas is a reducing agent, the gas would mean that the iron in the solution is more likely to be Fe²⁺ (and therefore the floc is more likely to be ferrous floc). Furthermore the hydrogen gas may form bubbles with the organofluorine, which thereby produces foam.

During the electrochemical treatment the pH may be raised due to the formation of hydroxyl ions. However, under relatively basic conditions (pH 7-10) most metal oxides and hydroxides become less soluble, which results in the formation of suspended metal oxy-hydroxide species. The stability of these suspensions may be determined by various factors including the zeta potential (or electric potential) in the interfacial double layer surrounding the metal oxy-hydroxide particle and the liquid. The presence of other charged material in the liquid (such as dissolved contaminants, especially dissolved ionic contaminants) may lower this zeta potential, decrease the stability of the suspended metal oxy-hydroxide and cause aggregation and floc formation. This aggregate or floc can form over a wide pH range, and floc from electrochemical (or electrocoagulation) reactions may have physical properties that are more disperse and easily compacted than aggregates formed by chemical coagulation. This means that the greater special extent of flocs formed electrochemically provide more capacity to entrain contaminants.

The electrochemical treatment may be performed at any suitable residence time, effective voltage per cell and flow rate. Suitable residence times, effective voltages per cell and flow rates are discussed below.

The method may include the step of adding a treatment agent to the liquid. Treatment agents may be as described below. The use of treatment agents may assist in the production of solids including fluorine. The use of treatment agents may assist in the initial separation of fluorine from the liquid and/or in the partitioning to either a generated foam or to a miscible polymeric liquid used to remove (or strip) fluorine containing compounds from the foam. The liquid can be separated following this treatment as outlined below. Treatment agents might also be used for the partitioning of generated fluorine to a solid floc or layered ferro, ferri-hydroxy, hydrotalcite, ettringite or similar layered hydroxide sludge. For example, suitable treatment agents may include chlorine-containing agents (such as chlorine salts such as sodium or potassium chloride). Without wishing to be bound by theory, it is believed that the chlorine, especially in combination with hydroxyl, sulfate and similar highly active radicals, may be able to displace fluorine in the organofluorine during the electrochemical treatment (or energetically displace fluorine from organofluorine compounds and intermediates encountered during the electrochemical treatment). Another suitable treatment agent may include alkaline earths, such as calcium or magnesium-containing agents (such as magnesium salts such as magnesium chloride). Without wishing to be bound by theory, it is believed that the alkaline earths (especially magnesium) may react with fluorine generated in the electrochemical treatment, especially to form highly insoluble magnesium fluoride compounds. Gaseous treatment agents may also be used in the electrochemical treatment to increase foam production (which may assist in capture and separation of fluorine containing contaminants present as surfactants). Furthermore, at least some chlorine gas may be formed at the anode from chloride ions and may react with molecular dioxygen to form dioxygen dichloride, which could assist in oxidising fluorine compounds. Treatment agents such as defoaming liquids may also be chosen to have a high affinity to fluorinated hydrocarbons present as foam (and may remain immiscible to a varying extent with cleaner water by virtue of relative insolubility—as will be known to those skilled in the art). Defoaming liquids may be chosen such that they preferentially absorb or react with dissolved fluorocarbons regardless of chain length whilst being separable from the cleaned, treated water by virtue of either their lower density or switchable miscibility at the oil-water interface encountered during treatment.

The electrochemical treatment may involve substantially laminar flow of liquid between the electrodes or turbulent flow of liquid between the electrodes; especially substantially laminar flow.

During the electrochemical treatment the electrodes may switch from anode to cathode. This may assist in the electrochemical treatment as when the electrodes switch reaction products previously close to an anode are now close to a cathode.

If needed, the efficiency of the electrochemical treatment in removing or depleting organofluorines may be improved by increasing the residence time, increasing the current applied to the liquid, slowing the flow rate or increasing the contact time of fluorine containing compounds (especially active fluorine containing compounds) with magnesium ions present or added. However, generally these steps may also decrease the throughput or increase the energy consumption of the system, which may not be desirable.

Without wishing to be bound by theory, it is also believed that longer chain organofluorines (such as perfluorooctanoate) may be more likely to form foam during the electrochemical treatment. However, shorter chain organofluorines (such as perfluorobutanoate) may be more likely to become part of the floc. Accordingly, it may be preferable to utilise dissolved air flotation (DAF) in combination with treatment agents (such as those described above and below) to maximise removal of fluoridated compounds from the liquid being treated.

Very strong oxidants may be needed to break C—F bonds due to their strength. Advantageously, in the electrochemical treatment free radicals (such as sulfate and hydroxyl) may be formed which are highly chemically reactive, but which have a very short lifetime. The electrochemical treatment may extend the lifetime of the free radicals due to the development of free radical chain reactions in the liquid being treated. If the lifetime of the free radicals are extended, then this can provide a more persistent oxidative potential in the electrochemical treatment. In any case, and without wishing to be bound by theory, it is believed that the free radicals in the electrochemical treatment may be able to attack C═C bonds and C—F bonds. Consequently, the electrochemical treatment may be effective in degrading the organofluorine compounds. Furthermore, it is believed that at least some chlorine gas formed at the anode from chloride ions may react with molecular dioxygen to form dioxygen dichloride, which could assist in oxidising fluorine compounds. Again, without wishing to be bound by theory, other chemicals which may form in the electrochemical treatment which may assist in degrading organofluorine compounds include oxygen difluoride (OF₂) and chloride trifluoride (ClF₃).

In one embodiment, the method further includes the step of removing floc from the electrochemically treated liquid. This step may include clarifying the electrochemically treated liquid in a clarifier. Floc may not settle in the electrochemical treatment (especially due to the residence time in the treatment), however given time the floc may settle in the clarifier. If necessary an oxidant (such as oxygen gas) may be bubbled through the clarifier to oxidise dissolved ferrous ions (Fe²⁺) to ferric ions (Fe³⁺). Ferric ions have greater affinity for some fluorinated compounds and consequently this (possibly in combination with oxygen or another treatment agent) may assist in further depleting the concentration of organofluorine compounds in the liquid.

In one embodiment, the method further includes the step of further treating the electrochemically treated liquid. In one example, the method may include the step of performing a second electrochemical treatment on the liquid to thereby produce foam and an electrochemically treated liquid, wherein the foam includes the organofluorine and/or degradation products thereof. In this example, the method may further include the step of separating the foam from the electrochemically treated liquid.

In one embodiment, the method may include the step of treating the separated foam. The method may include the step of degassing (or substantially degassing) the foam. The method may include the step of transferring the foam to a vessel, and the vessel may have a pressure below atmospheric pressure. The method may include the step of incinerating the foam or the degassed foam.

In a second aspect, the present invention provides a method of treating a liquid including an organohalogen, the method comprising:

electrochemically treating the liquid to thereby produce foam and an electrochemically treated liquid, wherein the foam includes the organohalogen and/or degradation products thereof, and separating the foam from the electrochemically treated liquid.

In one embodiment, the organohalogen is an organofluorine, an organochlorine, an organobromine or an organoiodine. The organohalogen may be mono, poly or per-halogenated. The organohalogen may be an organohalogen surfactant.

Features of the second aspect of the present invention may be as described for the first aspect.

### Electrochemical Treatment Apparatus in the Method

An apparatus for use in the method of the first or second aspects of the present invention may be as described below.

In one embodiment, the apparatus is an electrochemical liquid treatment apparatus, the apparatus including a treatment chamber including at least one inlet for entry of a liquid to be treated, and at least one outlet for exit of electrochemically treated liquid, and a plurality of electrodes positioned within the treatment chamber for electrochemical treatment of the liquid.

Any of the features described herein can be combined in any combination with any one or more of the other features described herein within the scope of the invention.

In one embodiment, the treatment chamber may include a plurality of inlets for entry of a liquid to be treated. The treatment chamber may further include a liquid disperser having a plurality of liquid passageways, wherein each said liquid passageway includes at least one inlet to the treatment chamber for entry of a liquid to be treated. Said liquid disperser may be for evenly dispersing the liquid to be treated relative to the electrodes in the treatment chamber, and may especially be a liquid manifold.

In a further embodiment, the plurality of electrodes positioned within the treatment chamber are angled from a vertical plane.

In another embodiment, the apparatus includes at least a first and a second treatment chamber, wherein the apparatus is configured so that liquid from said at least one outlet of the first treatment chamber flows into said at least one inlet of the second treatment chamber.

In a further embodiment, the apparatus is adapted to provide at least one treatment agent in the treatment chamber during electrochemical treatment of a liquid. In another embodiment, the treatment chamber further includes at least one treatment inlet for entry of a treatment agent for assisting in the treatment of the liquid.

The electrochemical treatment apparatus may be an electrolytic treatment apparatus. The apparatus may be adapted for electrocoagulation of a liquid or for performing electrochemical reactions on the liquid or contaminants within the liquid. The electrochemical reactions may change the state of specific components within the liquid (for example by reductive or oxidative processes).

The apparatus may include a treatment chamber (or a treatment vessel which defines a treatment chamber). The treatment chamber may be of any suitable size. In one embodiment, the treatment chamber is a large industrial unit. For example, the treatment chamber may accommodate from 60 kL to 1,000 kL of liquid; especially from 80 kL to 750 kL or from 100 kL to 600 kL; more especially from 125 kL to 500 kL or from 180 kL to 400 kL; most especially from 200 kL to 300 kL or about 250 kL of liquid.

The treatment chamber in another embodiment is portable. For example, the treatment chamber may accommodate less than 50 kL, 40 kL, 30 kL, 20 kL, 10 kL, 1 kL, 900 L, 800 L, 700 L, 600 L, 500 L, 400 L, 300 L, 200 L, 100 L, 80 L, 60 L, 40 L, 20 L or 10 L liquid. In another example the treatment chamber may accommodate greater than 40 kL, 30 kL, 20 kL, 10 kL, 1 kL, 900 L, 800 L, 700 L, 600 L, 500 L, 400 L, 300 L, 200 L, 100 L, 80 L, 60 L, 40 L, 20 L 10 L or 5 L liquid. In a further example, the treatment chamber may accommodate a range in which the upper and lower limits are as previously described.

Any suitable flow rate of liquid may flow through the at least one inlet, and thereby the treatment chamber. The optimal flow rate will depend on the size of the apparatus, the capacity of the treatment chamber and electrical conductivity (EC) of the liquid, which is typically a function of the total dissolved solids (TDS). The apparatus may be configured for a liquid flow rate of at least 500 mL/s; especially at least 0.5, 1, 1.5, 2.0, 2.5, 3, 5, 7, 10 or 13 L/s; more especially at least 0.5, 1, 1.5, 2.0, 2.5 or 3 L/s; most especially about 3 L/s. In another embodiment, the apparatus is configured for a liquid flow rate of less than 100 L/s; especially less than 90, 80, 70, 60, 50 or 40 L/s; more especially less than 30, 20 or 10 L/s; most especially less than 9, 8, 7, 6, 5 or 4 L/s.

The residence time of the liquid within the treatment chamber may be controlled or varied, depending on the size of the treatment chamber, the surface area of electrodes and/or the flow rate of the liquid. In some embodiments, the residence time is less than 10 minutes in the treatment chamber, especially less than 9, 8, 7, 6, 5, 4, 3, 2 or 1 minute in the treatment chamber, more especially about 30 seconds in the treatment chamber. In other embodiments, the residence time is from 5 seconds to 5 minutes in the treatment chamber, especially from 10 seconds to 2 minutes in the treatment chamber, more especially from 20 to 60 seconds in the treatment chamber, most especially from 30-45 seconds in the treatment chamber.

The treatment chamber may be configured for use at atmospheric pressure. The treatment chamber may be configured for use at greater than atmospheric pressure, for example at from greater than 1 atmosphere to 10, 9, 8, 7, 6, 5, 4, 3 or 2 atmospheres (especially from 1-3 atmospheres). Pressures of greater than atmospheric pressure may be used to accelerate a reaction within the treatment chamber. The treatment chamber may be configured for use at less than atmospheric pressure, for example at from less than 1 atmosphere to 0.1, 0.2, 0.3, 0.4, 0.5, 0.6, 0.7, 0.8 or 0.9 atmospheres. Pressures of less than one atmosphere may be beneficial for the removal of dissolved gases (such as carbon dioxide), thereby limiting, by way of example, the electrode passivating effects of bicarbonates and carbonates arising from the dissolved carbon dioxide. Gases may also be removed from the treatment chamber by use of a membrane system within the treatment chamber which operates at such reduced pressure so as to preferentially degas the liquid being treated.

The treatment chamber may be made of any suitable material. In one embodiment, the treatment chamber may be made of a polymer such as a polymer plastic (examples include high density polyethylene (HDPE), acrylonitrile butadiene styrene (ABS), polyvinyl chloride (PVC), polyethylene terephthalate (PET), a phenolic polymer plastic, polypropylene or polyethylene (PE)); a composite material made with a non-conducting fibre or panel (such as fibreglass) mixed with a resin or resin solution (such as a polyester, vinyl ester, epoxy, phenolic, polyimide, polyamide, polypropylene or polyether ether ketone (PEEK)) to produce a polymer matrix; a rubber; a metal such as steel, steel alloy, aluminium, or stainless steel (especially a metal insulated using a polymer plastic or composite material); a carbon fibre insulated using a polymer plastic or a composite material; or an insulating plastic (such as a phenolic insulating plastic) bonded (especially thermally) to a substrate such as a metal, concrete or compressed fibre-cement sheet. The treatment chamber may be machine finished. The treatment chamber may be partially or completely transparent (for example, the treatment chamber may be made of glass or a transparent plastic). A transparent treatment chamber may be advantageous for use with some treatment enhancers, such as UV light).

In one embodiment, the treatment chamber is configured so that the plurality of electrodes are positioned (or configured to be positioned) intermediate the at least one inlet and at least one outlet. In this embodiment liquid may enter the treatment chamber via the at least one inlet, pass between the plurality of electrodes, and then exit the treatment chamber via the at least one outlet. In a first example, the treatment chamber is configured so that the liquid flows substantially vertically through the treatment chamber. In this example, the at least one inlet may be positioned at the lower portion of the treatment chamber; and the at least one outlet may be positioned at the upper portion of the treatment chamber (i.e. the liquid substantially ascends through the chamber). Alternatively, the at least one inlet may be positioned at the upper portion of the treatment chamber; and the at least one outlet may be positioned at the lower portion of the treatment chamber (i.e. the liquid substantially descends through the chamber). In a second example, the treatment chamber is configured so that the liquid flows substantially horizontally through the treatment chamber. In this example the at least one inlet may be positioned at or adjacent to one side wall of the treatment chamber, and the at least one outlet may be positioned at or adjacent to an opposite side wall of the treatment chamber. In a third example, the treatment chamber is configured so that the liquid flows obliquely through the treatment chamber.

The treatment chamber may be a plurality of treatment chambers arranged in parallel. It may be advantageous to use a plurality of parallel treatment chambers in order to increase the external surface area of the treatment chamber during the electrochemical treatment. This may allow for greater exposure to, or penetration of, treatment enhancers (such as ultraviolet light, microwaves or ultrasonic waves (or ultrasonics)) during the electrochemical treatment.

The treatment chamber may be of any suitable shape or dimensions. The treatment chamber may have a square, circular, ovoid, elliptical, polygonal or rectangular cross-section. In one embodiment, the treatment chamber has a first wall, and one or more side walls. The first wall may include or be adjacent to the at least one inlet. The first wall may be distal to the electrodes and proximate to the at least one inlet. In this embodiment, the treatment chamber may include a second wall opposite to the first wall. The second wall may be distal to the electrodes and proximate to the at least one outlet. The second wall may be removable (such as if the second wall forms the lid of the chamber). The second wall may include or be adjacent to the at least one outlet. A side wall may also include or be adjacent to the at least one outlet. In another embodiment, the treatment chamber may include a base (first wall), a top or lid (second wall), and one or more side walls (especially if the treatment chamber is configured so that the liquid flows substantially vertically through the treatment chamber). It may be advantageous for the treatment chamber to include a lid so that pressure in the treatment chamber may accumulate as the electrochemical treatment progresses. If the liquid flows substantially vertically through the treatment chamber, then the at least one outlet may be positioned in the upper portion of the treatment chamber, and the at least one inlet may be positioned in the lower portion of the treatment chamber. A wall or panel of the treatment chamber may be at least partially removed or opened. In one embodiment, the treatment chamber may be cylindrical, especially a pipe. The base may be flat or planar, or may form a trough. The base may be of any suitable shape. The top or lid of the treatment chamber may be of the same dimensions as the base.

The one or more side walls may be planar, circular or ovoid. The second wall may include a vent or gas outlet for gases which evolve during the electrochemical process.

The inner surface of the first wall may be planar. The inner surface of the first wall may also be configured to direct the flow of liquid towards the electrodes. The inner surface of the first wall may include at least one (especially one) trough or channel which narrows to its base. The trough or channel may be substantially V-shaped. The trough or channel may be for directing the flow of water towards the electrodes. The first wall (especially the trough or channel) may include the at least one inlet, or the at least one inlet may be located within the trough or channel.

The apparatus may include any suitable number of treatment chambers (and optionally any number of defoaming chambers). In one embodiment, the apparatus includes at least a first and a second treatment chamber (each of which may be as herein described), wherein the apparatus is configured so that liquid from said at least one outlet of the first treatment chamber flows into at least one inlet of the second treatment chamber. In another embodiment, the apparatus includes at least a first and a second treatment chamber and a first and a second defoaming chamber (each of these may be as described herein), wherein the apparatus is configured so that liquid passes through the first treatment chamber, the first defoaming chamber, the second treatment chamber and the second defoaming chamber; especially wherein the liquid passes sequentially through the aforementioned chambers.

In one embodiment, the at least one inlet is a plurality of inlets. The treatment chamber may include at least 10 inlets, especially at least 15 inlets, more especially at least 20 inlets and most especially at least 30 inlets. The plurality of inlets may be for dispersing the liquid to be treated into the treatment chamber, especially for evenly dispersing the liquid to be treated throughout the treatment chamber.

Advantageously, by using a plurality of inlets the liquid may evenly enter the treatment chamber. This may improve even, or so-called laminar, fluid flow throughout the treatment chamber and said flow may maximise uniform and efficient contact between the electrodes positioned within the treatment chamber and the liquid being treated. Without wishing to be bound by theory, the benefits of encouraging such laminar or uniform flow may include some or all of reduced electrode and power consumption, improved transfer of electrical charge to the liquid to be treated, improved oxidation of impurities by short-lived free radicals (particularly refractory organic contaminants) and reduced electrode passivation.

The liquid may be dispersed into the treatment chamber by way of at least one liquid disperser, especially one liquid disperser. The liquid disperser may be separate to, or integral with, the first wall. The disperser may include a plurality of liquid inlets into the treatment chamber (these would be outlets from the disperser). In one embodiment, the treatment chamber includes a liquid disperser for dispersing the liquid to be treated into the treatment chamber, wherein said liquid disperser includes a plurality of inlets within the treatment chamber for entry of a liquid to be treated. Any suitable type of liquid disperser may be used.

In a first example, the disperser is a tube, especially a tube perforated along its length to provide a plurality of inlets into the treatment chamber. The tube may be of circular, ovoid, square, rectangular or triangular cross section. The tube may be perforated on all sides, or on all sides except for a side opposite to the electrodes. Advantageously, the disperser in this embodiment may be positioned within the at least one (especially one) trough or channel which narrows to its base in the first wall. If the first wall includes multiple troughs or channels, then a disperser may be positioned within each trough or channel. In one embodiment, the treatment chamber includes at least one liquid disperser for dispersing the liquid to be treated into the treatment chamber, wherein said liquid disperser includes a plurality of inlets within the treatment chamber for entry of a liquid to be treated, and wherein within each said at least one channel is positioned one said liquid disperser.

In a second example, the disperser includes a plurality of liquid passageways, wherein each said liquid passageway includes at least one inlet to the treatment chamber for entry of a liquid to be treated. The disperser in this example may be a manifold. Said plurality of liquid passageways may include at least one longitudinal liquid passageway and/or at least one transverse liquid passageway. Said passageways may be in fluid communication with each other. For example, the disperser may include at least one liquid entry point, at least one longitudinal liquid passageway and/or at least one transverse liquid passageway. At least one or each of the liquid passageways may include at least one and preferably a plurality of inlets to the treatment chamber. The liquid passageways may be arranged in any suitable way.

Advantageously, computational fluid dynamic (CFD) modelling may be used to provide for laminar flow across the surface of the electrodes within the treatment chamber. Typically, the at least one transverse liquid passageway may be in liquid communication with the at least one longitudinal liquid passageway. The at least one liquid entry point may be in liquid communication with or abut either the at least one longitudinal liquid passageway, or the at least one transverse liquid passageway. The at least one longitudinal liquid passageway may be in fluid communication with, and extend from (especially at from 30 to 150 degrees to; more especially at from 60 to 120 degrees to; most especially at about 90 degrees to) the at least one transverse liquid passageway. The inlets to the treatment chamber may be provided by the outlets of the liquid disperser. In the second example, the disperser (especially manifold) may include at least one longitudinal liquid passageway in fluid communication with at least one transverse liquid passageway, wherein the at least one longitudinal liquid passageway and/or the at least one transverse liquid passageway include at least one inlet to the treatment chamber for entry of a liquid to be treated. The at least one inlet and/or disperser may be positioned beneath the plurality of electrodes (if the liquid substantially ascends as is passes through the treatment chamber).

The disperser may include a diffuser for evenly distributing the liquid exiting the disperser. However, depending on the results of the aforementioned CFD modelling or other factors, the diffuser may not be necessary. When a liquid enters the disperser the pressure may be higher at the liquid entry point than at a position on the disperser furthest from the liquid entry point. To counter this, the disperser may include a plurality of inlet openings, wherein the inlet openings are larger at the liquid entry point end of the disperser, and the inlet openings are smaller at the position on the disperser furthest from the liquid entry point.

The disperser may be made of any suitable material. In one embodiment, the disperser may be made of the same types of materials as previously described for the treatment chamber. In one embodiment, the disperser is made from welded polypropylene or polyethylene, polyester or epoxy resin fibreglass, a polymer, rubber, or cast or extruded components based on polymer plastic materials.

The apparatus may further include a flow aligner (or flow distributor) for aligning the flow of the liquid between the electrodes. The flow aligner may also be for distributing the liquid between the electrodes. The flow aligner may be positionable between the at least one inlet and the electrodes. The flow aligner may be positioned intermediate the at least one inlet and the electrodes. A flow aligner may be advantageous as the liquid between the electrodes and the at least one inlet (or if the liquid substantially ascends through the treatment chamber, beneath the electrodes) may especially be turbulent. The flow aligner may assist the liquid in moving substantially or uniformly along the same longitudinal axis as the plurality of electrodes, which in turn may improve the contact time and hence electrochemical reaction between the liquid to be treated and the electrodes. The flow aligner may be integrally formed with the treatment chamber, or may be removable and/or replaceable.

The flow aligner may be a partition (or wall or barrier) (especially a removable partition) defining a plurality of apertures for passage of the liquid. The apertures defined by the removable partition may be consistently spaced and sized so that liquid flows evenly through the partition. The flow aligner may extend between the side walls of the treatment chamber. The apparatus may be configured so that when in use, the liquid pressure on the side of the partition proximate to the at least one inlet is greater than the liquid pressure on the side of the partition proximate to the electrodes. In one embodiment, the wall or partition is configured to provide a greater liquid pressure on the side of the wall or partition proximate to the at least one inlet than on the side of the wall or partition proximate to the electrodes when the apparatus is in use. Advantageously, this may assist the even, uniform or laminar flow of liquid between the electrodes. In an alternative embodiment, the treatment chamber may have only one inlet. In this embodiment the volume of liquid beneath the flow aligner may be sufficiently large so that turbulence in the liquid is ameliorated after the liquid passes through the flow aligner. Depending on a range of fluid, electrode and cell design parameters, such further design refinement could be influenced or determined by the CFD modelling as described above.

The flow aligner (or removable partition or wall) may be in the form of a plurality of segments, such that any one segment may be removed independently of the others. Each said segment may abut the adjoining segment, or each said segment may be in close proximity with the adjoining segment. In one embodiment, the apparatus includes a plurality of electrode holders and each said electrode holder includes a segment of the flow aligner. The flow aligner may be in the faun of at least one plate (or panel) (especially a plurality of plates), wherein each said plate defines a plurality of apertures for passage of the liquid. The flow aligner may define a plurality of apertures each having a polygonal (especially hexagonal), circular or ovoid shape.

The combination of a disperser and a flow aligner (especially a disperser in the form of a perforated tube positioned within a trough or channel in the first wall, and a flow aligner in the form of a partition (or wall) defining a plurality of apertures for passage of the liquid) may promote the even, uniform or laminar flow of liquid between the electrodes, to thereby maximise the transfer of electrical charge and the efficiency of the electrochemical reaction. In this way, so-called “deadspots” in the flow of liquid through the reaction chamber can be minimised.

The flow aligner may be made of any suitable material, but especially may be made of a non-conductive material. The flow aligner may be made of the materials discussed above for the treatment chamber. The flow aligner may be especially made from a composite material made with a non-conducting fibre or panel (such as fibreglass) mixed with a resin or resin solution (such as a polyester, vinyl ester, epoxy, phenolic, polyimide, polyamide, polypropylene or polyether ether ketone (PEEK)) to produce a polymer matrix; a polymer plastic such as high density polyethylene (HDPE), polyethylene (PE), polyethylene terephthalate (PET), polyvinyl chloride (PVC); a phenolic polymer plastic; or be fabricated from a number of composite materials including carbon fibre (for example a carbon fibre insulated using a polymer plastic or a composite material) and variations thereof.

The inventors have performed computational fluid flow simulations on various treatment chamber configurations. The inventors have also studied fluid flow and pH variations within the treatment chamber during electrochemical treatments using pH sensitive indicators, and by inclusion of synthetic resin beads (of size less than 0.5 mm) in the fluid flow within the treatment chamber. These techniques were used to identify preferential channelling of the fluid flow. Advantageously, the inventors have found that inclusion of a flow aligner intermediate the at least one inlet and the electrodes, especially a flow aligner in the form of a partition defining a plurality of apertures provides decreased preferential channelling of the fluid flow, and increased uniformity of the fluid flow through the treatment chamber.

The apparatus may be configured to electrochemically treat the liquid in the presence of at least one treatment enhancer or at least one treatment agent.

As used herein, the term “treatment enhancer” refers to matter or energy (including radiation, sound or photons) that is capable of penetrating a solid wall of the treatment chamber to enhance reactions within the treatment chamber. Exemplary treatment enhancers include electromagnetic radiation and sonic waves. Electromagnetic radiation may include one or more of radiowaves, microwaves, infrared radiation, visible light, ultraviolet radiation (including ultraviolet-C light), X-rays and gamma rays. Sonic waves may include ultrasonic, infrasonic and audible waves. In one embodiment, the treatment enhancer may be a microwave or ultraviolet radiation, or ultrasonic sound waves. The treatment enhancer may accelerate or modify reactions in the treatment chamber (especially reactions involving contaminants) during the electrochemical treatment. The treatment enhancer may also reduce passivating accumulations on the electrodes (especially the cathodes; sonic waves may be suitable for this purpose, especially ultrasonic waves).

The at least one treatment agent may be a fluid (including a gas or a liquid) or a solid. The at least one treatment agent may be a plurality of treatment agents. The at least one treatment agent may assist in the treatment of the liquid. The at least one treatment agent may act as a reactant or a catalyst during the electrochemical treatment, or it may modify or adjust the properties of the reactants, the liquid (solvent) or the products of the electrochemical treatment, or it may be inert during the electrochemical treatment. The at least one treatment agent may be used to form a reactant or catalyst in situ during the electrochemical treatment. Each said at least one treatment agent may also perform multiple functions. For the avoidance of doubt, the term “treatment agent” does not include chemicals produced in the course of an electrochemical treatment (such as hydrogen gas, metal ions generated by a sacrificial anode, and hydroxyl ions and hydroxyl or sulfate radicals produced at the cathode); the term “treatment agent” refers to chemical matter deliberately added to the liquid to be treated by an operator during, prior to or after the electrochemical treatment. Electrodes per se, for example, are not treatment agents, although an electrode may be doped with a treatment agent so that the treatment agent is released, or acts as a catalyst, during the electrochemical treatment as the anode corrodes. For example, the electrodes may be doped with an alkaline earth metal.

The at least one treatment agent may be an oxidant, reductant or catalyst. The at least one treatment agent may form an oxidant, reductant or catalyst in situ in the treatment chamber during the electrochemical treatment. The at least one treatment agent may be selected from the group consisting of: an oxidant, a reductant, a homogenous or heterogeneous catalyst, a pH modifier (an acidifier (or acid) or a basifier (or base/alkali)), a surfactant, a defoaming agent, a conductivity modifier (for modifying the conductivity of the liquid to be treated), a chelant (for chelating with metal ions in the liquid), a viscosity modifier (for modifying the viscosity of the liquid or the floc), a ligand (for forming a catalyst), and a buoyant gas (which may advantageously improve or increase the liquid flow velocity between the electrodes and/or improve the reaction of components within this liquid).

Increasing the liquid flow velocity between the electrodes may be advantageous for several reasons. First, increased liquid flow velocity between the electrodes may reduce the accumulation of dangerous gases, such as hydrogen, chlorine and hydrogen sulfide at the electrodes. Although such gases are typically formed in the electrochemical process, in the absence of high current densities the formation rate of such gases is usually so low that poor clearance of these gases occurs. The addition of a buoyant gas to the treatment chamber may improve the clearance of such dangerous gases.

A second and related advantage of increasing the liquid flow velocity between the electrodes is that passivation of the at least one cathode may be reduced, as higher liquid flow rates decreases the potential for material build-up (such as floc, magnetite or other passivating coating) on the at least one cathode.

A third advantage of increasing the liquid flow velocity between the electrodes is that the liquid is more likely to push any floc (including, for example, coalescing oil droplets) or foam being formed to the top of the treatment chamber, where the foam may be efficiently removed or recovered for further processing. This also may prevent the floc from settling on the base of the treatment chamber.

Exemplary oxidants may include permanganate (such as potassium or sodium permanganate), hydrogen peroxide, an inorganic peroxide, a peroxysulfates, a disulfate, a peracid (such as an organic or inorganic peracid—an exemplary example is meta-chloroperoxybenzoic acid), oxygen gas, ozone, a halogen gas (such as fluorine or chlorine), nitric acid, sulfuric acid, a chlorite, a chlorate, a perchlorate, hypochlorite, and salts of the aforementioned oxidants. Exemplary reductants may include carbon monoxide, iron (II) compounds, hydrogen sulfide, disulfide, formic acid, sulfite compounds, boron reducing agents and hydrogen gas. Other oxidants and reductants would be known to a skilled person. The oxidant or reductant may assist in the electrochemical (or electrolytic) conversion of contaminants (especially to enable removal or recovery or separation of the contaminants). The oxidant may assist in enhanced oxidative processes (EOP), such as for refractory contaminants. However, the treatment agent may especially be a reductant.

The at least one treatment agent may be for reaction with certain contaminants in the liquid to be treated (for example, reaction with organofluorines), may be used to adjust the properties of the liquid being treated (for example to adjust the pH of the liquid), or may be for adjusting the properties of the foam or floc (for example the agglomeration, viscosity, flowability or settling velocity of the foam or floc).

The at least one treatment agent may be a gas (which may be inert, an oxidant or a reductant, for example). The gas may be a buoyant gas. The gas may be selected from one or more of the group consisting of: air, hydrogen, oxygen, ozone, carbon monoxide, carbon dioxide, sulphur dioxide, hydrogen sulfide, nitrogen, chlorine, fluorine, chlorine dioxide, ammonia, or a combination thereof; especially hydrogen, hydrogen sulfide, chlorine, carbon monoxide, air, carbon dioxide, or a combination thereof; more especially air, carbon dioxide, hydrogen sulfide, hydrogen, carbon monoxide, or a combination thereof. A plurality of treatment agents may enter the treatment chamber, such as an inert gas and an oxidant or reductant.

A said at least one treatment agent may be added to the liquid after the chemical treatment (either before or after the liquid exits the treatment chamber). For example, if the liquid provided after the electrochemical treatment is transferred to a tank (such as a clarification tank) a said at least one treatment agent may be added to encourage the separation (typically by gravity settling) of floc.

The apparatus may be adapted to provide at least one treatment agent in the treatment chamber during electrochemical (or electrolytic) treatment of the liquid. The at least one treatment agent may be provided within the treatment chamber in any suitable way.

In a first example, a said at least one treatment agent may be mixed with the liquid to be treated before the liquid enters the treatment chamber. The apparatus may include a mixer in fluid communication with the at least one inlet for a liquid to be treated, wherein the mixer is for mixing at least one treatment agent (which may be a liquid, gas or solid) with the liquid to be treated, before the liquid to be treated passes through the at least one inlet. Alternatively, the treatment agent may be provided on a liquid conduit to the treatment chamber, such as a pipe or manifold for transferring the liquid to be treated to the treatment chamber.

In a second example, a said at least one treatment agent may be provided on a surface within the treatment chamber. For example, a catalyst may be provided on an inner side wall of the treatment chamber, on the walls at which the electrodes are held (e.g. on an electrode holder), or within at least one of the electrodes (such as via a doped-electrode), in which the treatment agent may be chemically alloyed within or physically attached, laminated or layered to the electrode materials. Said treatment agent may be released from the doped electrode when the electrode functions as an anode (at which time the anode releases metal ions into the liquid)). An exemplary doped electrode is a cerium doped electrode, although several other rare earth or precious metals when coated onto inert electrodes such as titanium, will be known to those skilled in the art.

In a third example, a said at least one treatment agent may be provided following electrochemical treatment.

In a fourth example, a said at least one treatment agent may enter the treatment chamber through at least one treatment inlet. The treatment chamber may include at least one treatment inlet (or a plurality of treatment inlets, especially in fluid communication with each other) for each or each mixture of treatment agents. The treatment chamber may include at least 10 treatment inlets, especially at least 15 inlets, more especially at least 20 inlets, and most especially at least 30 inlets. Advantageously, by using a plurality of inlets for entry of a treatment agent, the treatment agent may evenly enter the treatment chamber. This may permit a consistent concentration and/or distribution of the treatment agent in the liquid before the treatment agent is proximate to the electrodes, which in turn may allow for improved reaction of the liquid to be treated. When the treatment agent is a gas, a plurality of inlets for a gas treatment agent may improve even fluid flow throughout the treatment chamber and may maximise efficient contact between the electrodes positioned within the treatment chamber and the liquid being treated. A plurality of inlets for a gas treatment agent may also improve the distribution of the gas within the liquid being treated, which in turn may improve the effect of the gas in chemical/electrochemical reactions within the treatment chamber.

The at least one treatment inlet may be at least one fluid treatment inlet (the fluid may include gases and liquids, and for example, liquids including suspended solids). For avoidance of doubt, the term “fluid treatment inlet” does not mean that the treatment agent is in fluid form (although it may be), only that a fluid at least including the treatment agent passes through the fluid treatment inlet. The at least one fluid treatment inlet may be in the form of a fluid treatment disperser. The at least one fluid treatment inlet may be at least one liquid treatment inlet (again, the term “liquid treatment inlet” means that a liquid at least including the treatment agent passes through the liquid treatment inlet). The at least one liquid treatment inlet may be in the form of a liquid treatment disperser. The liquid treatment disperser may be as described above for the liquid disperser.

The at least one treatment inlet may be an inlet for a gas treatment agent (i.e. a gas inlet). The treatment chamber may further include a gas treatment disperser having a plurality of gas inlets to the treatment chamber. Said gas treatment disperser may be for evenly dispersing the gas relative to the electrodes in the treatment chamber, and may especially be a gas manifold.

The gas disperser may include a plurality of gas passageways, wherein each said gas passageway includes at least one inlet for entry of a gas. Said plurality of gas passageways may include at least one longitudinal gas passageway and/or at least one transverse gas passageway. Any suitable type of gas disperser may be used. For example, the gas disperser may include at least one gas entry point, and at least one longitudinal gas passageway and/or at least one transverse gas passageway. Each of the gas passageways may include at least one and preferably a plurality of gas inlets. The gas passageways may be arranged in any suitable way. Typically, the at least one transverse gas passageway may be in gaseous communication with the at least one longitudinal gas passageway. The at least one gas entry point may be in gaseous communication with or abut either the at least one longitudinal gas passageway, or the at least one transverse gas passageway. The at least one longitudinal gas passageway may be in gaseous communication with, and extend from (especially at from 30 to 150 degrees to; more especially at from 60 to 120 degrees to; most especially at about 90 degrees to) the at least one transverse gas passageway. The at least one gas inlet to the treatment chamber may be provided by outlets of the gas disperser. The treatment chamber may include at least 20 gas inlets.

The at least one treatment inlet may be positioned at any suitable point or points in the treatment chamber. In one embodiment, the at least one treatment inlet is positioned between the electrodes and the first wall (especially between the flow aligner and the first wall). If the liquid substantially ascends as it passes through the treatment chamber, then the at least one treatment inlet may be positioned beneath the electrodes (especially so that the treatment agent substantially rises as it travels through the treatment chamber). In one embodiment, the at least one treatment inlet (including a fluid treatment disperser) is integral with the first wall (or base) of the treatment chamber. In another embodiment, the at least one treatment inlet (including a fluid treatment disperser) is removable from the treatment chamber.

The treatment chamber may include at least one treatment inlet (or a plurality of treatment inlets in fluid communication with each other) for each or each mixture of treatment agents. When the treatment chamber includes treatment inlets for different types of treatment agents (for example, a liquid treatment disperser and a gas disperser), these may be positioned relative to each other and to the at least one liquid inlet in any suitable way. For example, if the apparatus includes a liquid disperser and a gas disperser, the liquid disperser may be adjacent or proximate to the gas disperser (for example, the liquid disperser may be on top of, beneath, or beside the gas disperser). Similarly, if the apparatus includes a liquid treatment disperser and a liquid disperser, the liquid treatment disperser may be adjacent or proximate to the liquid disperser (for example, the liquid disperser may be on top of, beneath, or beside the liquid treatment disperser).

The at least one outlet for exit of electrochemically (or electrolytically) treated liquid may be located in any suitable position in the treatment chamber. However, the at least one outlet especially may be located such that the electrodes are positioned intermediate the at least one outlet and the at least one inlet. In one embodiment, the at least one outlet is located in or is positioned adjacent the second wall of the treatment chamber. The at least one outlet may be positioned above the electrodes (especially at the top of the treatment chamber), especially so that the liquid substantially rises as it travels through the treatment chamber. The at least one outlet may be in the form of an aperture in the side of a wall of the treatment chamber.

In a first example, the at least one outlet may include at least two outlets, especially one outlet.

Alternatively, the floc may be separated from the treated liquid after the liquid exits the treatment chamber. For example, the apparatus may further include a vessel in fluid communication with the at least one outlet (a defoaming chamber, as discussed below, may be intermediate the at least one outlet and the vessel). Electrochemically treated liquid exiting the liquid outlet may flow to the vessel for separation of the floc from the liquid (this may be assisted by introducing a ballast component such as ultrafine sand or dense magnetite). In one embodiment, the vessel may be a clarifier for clarifying the liquid. The vessel may include at least one liquid outlet and at least one floc outlet.

The apparatus may also include a foam mover for moving foam, especially on the surface of the liquid in the treatment chamber. A treatment agent could also be selected to provide greater foam miscibility, recovery or improved foam buoyancy, as described above. The foam mover may be in the form of a skimmer. The foam mover may be configured for moving the foam towards the at least one foam outlet, and may assist in providing a horizontal flow for the liquid at the top of the treatment chamber (or at the top of the vessel). The foam mover may be positioned substantially above, below, at or near the surface of the liquid in the treatment chamber.

The foam mover may include at least one foam driver for driving the foam towards the at least one foam outlet, and especially a plurality of foam drivers (these may be in the form of a paddle or projection). The at least one foam driver may be mounted to or mounted relative to a belt, strap, chain or cable. The belt, strap, chain or cable may be turned by a belt drive. The belt drive may be partly flexible. The belt drive may include at least one wheel, especially at least two wheels, more especially two wheels. The at least one wheel may include teeth, and may be in the form of a cog or sprocket.

The apparatus may include a foam collector. The foam collector may collect foam at the least one outlet. The foam collector may include a filter. The filter may be configured to substantially retain foam, but to allow liquid to permeate. The filter may be a mesh. The mesh may be a stainless steel mesh. The mesh may be a 20 mesh. The mesh may have an aperture size of from 400 to 1,500μ, especially from 500 to 1,200μ, more especially from 600 to 1,100μ, most especially from 700 to 1,000μ. The mesh may have an aperture size of from 800 to 1,000μ, especially from 850 to 950μ. In one embodiment, the method includes the step of collecting the separated foam using a foam collector located in fluid connection with the at least one outlet for exit of electrochemically treated liquid; wherein the foam collector includes a mesh filter and a suction source.

The foam collector, or the filter, may be in fluid connection with the at least one outlet, especially in register with the at least one outlet. The foam collector may include a nozzle. The nozzle may include the filter. The nozzle may include a collection end and a vacuum end. The filter may be positioned at the collection end. The vacuum end may be connected to a fluid conduit, such as a hose. The nozzle (or the hose) may be in fluid communication with a vacuum or suction source (such as a pump). The nozzle may be in fluid communication with a foam vessel for collecting foam. The foam vessel may have a pressure below atmospheric pressure. Keeping the foam vessel at reduced pressure may assist in drawing the bubbles out of the foam.

The apparatus may also include a defoamer. The defoamer may be for decreasing the volume of foam (or bubbles) in the electrochemically treated liquid after the electrochemical treatment and after the foam collector. The defoamer may be for decreasing the volume of foam (or bubbles), whilst simultaneously capturing the polyfluorinated components of the electrochemically treated liquid after the electrochemical treatment and after the foam collector. The defoamer may include one or more nozzles for spraying liquid onto the foam. As the liquid is sprayed onto the foam, the liquid droplets pierce the foam, releasing the trapped gas and decreasing the foam volume. Through choice of liquid, the droplets may also potentially enable improved capture of both long and short chain fluorocarbons. The nozzle may be adjustable to modify the velocity of the sprayed liquid and the size of the sprayed liquid droplets. The apparatus may include one, or a plurality of defoamers. The nozzle may produce a jet, or produce a mist. The liquid sprayed by the nozzle may be electrochemically treated liquid from the treatment chamber. In the case of perflurorocarbon compounds, the liquid may be chosen to be miscible and have a high affinity to bond or adsorb selectively to polyfluorinated compounds whilst being partially or substantially immiscible with water. The defoamer may include a pump for pumping the liquid through the nozzles. The nozzles may be located below the foam collector. In one embodiment, degassing the foam includes placing the foam under reduced pressure, or by spraying liquid onto the foam.

The defoamer may be present in a defoaming chamber (the apparatus may include a defoaming chamber which includes a defoamer). In one embodiment, the apparatus may further include a defoaming chamber (or a defoaming vessel which defines a defoaming chamber). Liquid exiting the treatment chamber through the at least one outlet may flow to the foam collector, and then through the filter. The liquid then passes to the defoaming chamber and may pass therethrough to an outlet at the base of the defoaming chamber. One, or a plurality of defoamers may be positioned (especially vertically positioned) within the defoaming chamber to spray liquid on foam passing (or falling) through the chamber. The defoaming chamber may also include one or more (especially one or two) flow diverters. The flow diverters may be positioned within the defoaming chamber to divert the flow of liquid to thereby increase the liberation of gas from the liquid. The flow diverters may be a plate, especially a substantially vertically mounted plate within the defoaming chamber.

At least a first flow diverter may provide a weir inside the defoaming chamber. A second flow diverter may be positioned intermediate said first flow diverter and the inlet to the defoaming chamber (which may be the outlet of the treatment chamber). The second flow diverter may provide an underflow weir (under which the fluid passing through the defoaming chamber passes). The bottom of the second flow diverter may extend lower than the top of the first flow diverter. The first and/or second flow diverter may be substantially vertical. The first and/or second flow diverter may be a wall or plate. Advantageously, the first and second flow diverters may trap foam entering the defoaming chamber between the second flow diverter and the defoaming chamber inlet. Fluid entering the defoaming chamber may fall onto the trapped foam to assist in decomposing the foam.

The defoaming chamber may include an outlet for exit of defoamed liquid. Said defoaming chamber outlet may be located at the base of the defoaming chamber.

Advantageously, the defoaming chamber may break down residual foam in the electrochemically treated water and/or may perform the function of transferring the polyfluorinated compounds liberated in the process described above to a more easily separated component within the electrochemically treated water. If such foam is not broken down, readsorbed to a water immiscible component and/or is introduced into a pump it can create difficulties due to the trapped gas within the foam (for example creating air locks).

In one embodiment, the plurality of electrodes includes at least one anode, at least one cathode and at least one electrical conductor, wherein said at least one electrical conductor is positioned intermediate said at least one cathode and said at least one anode.

As used herein, the term “electrical conductor” refers to an electrode which is not intended to accept power from a power source external to the treatment chamber. The electrical conductor may obtain an electrolytic charge from the electron flow in an electric field contained within the vessel in which it resides.

The plurality of electrodes may be selected from the group consisting of an anode, a cathode and an electrical conductor. In use, the apparatus includes at least one anode and at least one cathode. However, the electrodes may all be of similar structure and only become an anode, a cathode or an electrical conductor by virtue of the power connected to the electrode (or lack thereof in the case of an electrical conductor). Each said at least one electrical conductor may be positioned between at least one anode and at least one cathode.

The apparatus may include from 10 to 1000 electrodes; especially from 20 to 500 electrodes; more especially from 30 to 250 electrodes; most especially from 40 to 100 electrodes.

In one embodiment, from 2 to 12 electrodes in the apparatus are connected to a power source; especially from 2 to 10 or from 2 to 8 electrodes in the apparatus are connected to a power source; more especially from 2 to 6 or from 2 to 4 electrodes in the apparatus are connected to a power source; most especially three electrodes in the apparatus are connected to a power source. If three electrodes in the apparatus are connected to a power source, the two terminal electrodes (i.e. at each end of the plurality of electrodes) will have the same polarity (i.e. either an anode or a cathode) and an electrode intermediate the terminal electrodes (especially substantially equidistant between the terminal electrodes) will have the opposite polarity (i.e. either an anode or a cathode). The remaining electrodes in the plurality of electrodes will be electrical conductors. In one embodiment, the apparatus is configured so that from 5% to 25% of the electrodes in the apparatus are anodes or cathodes; especially from 8% to 20% of the electrodes in the apparatus are anodes or cathodes; more especially from 10% to 20% of the electrodes in the apparatus are anodes or cathodes or from 10% to 15% of the electrodes in the apparatus are anodes or cathodes. In another embodiment, the apparatus is configured so that from 0.5% to 25% of the electrodes in the apparatus are anodes or cathodes; especially from 0.5% to 15% of the electrodes in the apparatus are anodes or cathodes; more especially from 0.5% to 10% of the electrodes in the apparatus are anodes or cathodes or from 0.5% to 5% of the electrodes in the apparatus are anodes or cathodes. In one embodiment, about 2.5% of the electrodes in the apparatus are anodes or cathodes.

Each electrode, a set of electrodes, or the plurality of electrodes may be replaceable and/or removable. For example, the electrodes may be removable from the treatment chamber by means of an overhead gantry. The electrodes may be removed for temporary storage as a set (for example in horizontal racks above the unit), or can be replaced individually such as when an electrode loses its anodic potential through diminished surface area, for example by corrosion.

Each electrode may be of any suitable shape, although certain shapes facilitate easy removal from the treatment chamber. For example, each electrode may be curved or planar, especially planar. Each electrode may also be, for example, of square, rectangular, trapezoidal, rhomboid, or polygonal shape; especially of rectangular or square shape. Each electrode may also be of solid construction, or may include a plurality of apertures. Each electrode may be especially of solid construction. In one embodiment, each electrode is a plate. In another embodiment, a said electrode or a portion of the plurality of electrodes may be of circular, ovoid, or elliptical cross section. In this embodiment, the electrodes in the portion of the plurality of electrodes may be positioned so that one electrode is inside the adjacent electrode. For example, a portion of the plurality of electrodes may be concentrically positioned (especially when said electrodes are cylindrical in shape).

Each electrode may be made of any suitable material. Exemplary materials include aluminium, iron, steel, stainless steel, steel alloy (including mild carbon steel), magnesium, titanium and carbon. In another embodiment, each electrode may be made of an alloy of or containing a material selected from the group consisting of: aluminium, iron, steel, magnesium, titanium and carbon. Each electrode may be selected depending upon the liquid to be treated, the contaminants in the liquid, the floc to be created and the relative cost of the various metallic components or alloys within the electrodes at the time. Each said electrode within the apparatus may be the same or different, and may include the same metal or different metals (for example depending on the desired performance). A said or each electrode may also include one or more treatment agents for release during the electrochemical treatment. A said or each electrode may also include one or more treatment agents to catalyse specific reactions, especially oxidative reactions, during the electrochemical treatment.

The electrodes may be positionable above or below the level of the liquid in the treatment chamber. However, the electrodes are especially positionable below the level of the liquid in the treatment chamber. If the liquid substantially ascends as it passes through the treatment chamber, this arrangement may advantageously not impede liquid, foam or floc horizontal flow at the surface of the liquid.

The electrodes may be positionable within the reaction chamber at any suitable angle. For example, the electrodes or a portion of the electrodes (such as an upper portion) may be angled from a vertical plane (obliquely configured) or a plane perpendicular to the first wall of the treatment chamber. The electrodes may be positioned substantially vertically or at an angle of from 10 to 30 degrees from the vertical or a plane perpendicular to the first wall of the treatment chamber, especially at an angle of 10 to 15 degrees or about 15 degrees from the vertical or a plane perpendicular to the first wall of the treatment chamber. In one example, the electrodes or a portion of the electrodes (such as an upper portion or portion proximate to the at least one outlet) may be positioned at an angle of from 5 to 40 degrees from the vertical or a plane perpendicular to the first wall of the treatment chamber, especially from 5 to 35 degrees from the vertical or a plane perpendicular to the first wall of the treatment chamber, more especially from 10 to 30, 10 to 15 or 15 to 30 degrees from the vertical or a plane perpendicular to the first wall of the treatment chamber. In other examples, the electrodes or a portion of the electrodes (such as an upper portion or portion proximate to the at least one outlet) may be positioned at less than 40 degrees from the vertical or a plane perpendicular to the first wall of the treatment chamber, more especially less than 35, 30, 25, 20, 15, 10 or 5 degrees from the vertical or a plane perpendicular to the first wall of the treatment chamber. In further examples, the electrodes or a portion of the electrodes (such as an upper portion or portion proximate to the at least one outlet) may be positioned at greater than 5, 10, 15, 20, 25, 30 and 35 degrees from the vertical or a plane perpendicular to the first wall of the treatment chamber. In other embodiments, the electrodes may be substantially vertical (or in a vertical plane) or substantially in a plane perpendicular to the first wall of the treatment chamber. The inventors have found that different liquids react differently to different electrode angles. For the avoidance of doubt, as used herein if the first wall includes a trough or a channel then the phrase “a plane perpendicular to the first wall of the treatment chamber” refers to a plane perpendicular to the base of the trough or channel.

Each electrode may be of any suitable thickness, for example from 1 mm to 20 mm thick, especially from 1 mm to 10 mm thick, more especially from 1 mm to 5 mm thick, most especially about 3 mm thick. In some embodiments, each electrode is less than 20 mm thick, especially less than 19, 18, 17, 16, 15, 14, 13, 12, 11, 10, 9, 8, 7, 6, 5, 4, 3 or 2 mm thick. In other embodiments, each electrode is greater than 0.5 mm thick, especially greater than 1, 2, 3, 4, 5, 6, 7, 8, 9, 10, 11, 12, 13, 14, 15, 16, 17, 18 or 19 mm thick. In a further embodiment, thickness of the electrode may be a range in which the upper and lower limits are as previously described. In one embodiment, the electrodes are from 1 mm to 10 mm thick, especially about 3 mm thick.

The electrodes may be spaced at any suitable distance. For example, the electrodes may be (especially on average) from 1 mm to 150 mm apart, especially from 1 mm to 100 mm apart or from 1 mm to 50 mm apart, more especially from 1 mm to 10 mm apart. The electrodes may be (especially on average) from 1 mm to 5 mm apart, or from 1.5 mm to 4.5 mm apart; more especially about 3 mm apart. In some embodiments, the electrodes are (especially on average) less than 150 mm apart, especially less than 140, 130, 120, 110, 100, 90, 80, 70, 60, 50, 40, 30, 25, 20, 15, 10, 9, 8, 7, 6, 5, 4 or 3 mm apart. In other embodiments, the electrodes are (especially on average) greater than 1, 2, 3, 4, 5, 6, 7, 8, 9, 10, 15, 20, 25, 30, 40, 50, 60, 70, 80, 90, 100, 110, 120, 130 or 150 mm apart. The electrodes may also be a range apart in which the upper and lower limits are as previously described. When the treatment chamber includes more than 2 electrodes, each electrode may be the same distance apart or different distances apart.

The electrodes may be held apart in any suitable way. For example, the treatment chamber may include guides for holding the electrodes in position. In one embodiment, the guides may be grooves or slots positioned in opposite walls of the treatment chamber. The guides may be made from a high-density, electrically insulating polymeric material, such as HDPE or PVC, or a material as discussed below for the electrode holder.

In one embodiment, the electrodes are from 1 mm to 10 mm thick, more especially from 1 mm to 5 mm thick; and the electrodes are from 1 mm to 10 mm apart, more especially from 1 mm to 5 mm apart. Using thinner electrodes positioned close together enables a greater number of electrodes to be positioned within the treatment chamber. This increases the surface area of the electrodes in contact with the liquid, which may enhance the electrochemical treatment of the liquid.

To improve fluid flow, the electrodes may have a tapered lower edge or edge proximate to the at least one inlet. The lower edge (or edge proximate to the at least one inlet) of the electrodes may be tapered to an angle of about 4, 5, 6, 7, 8, 9, 10, 11, 12, 13, 14, 15, 16, 17, 18, 19 or 20 degrees relative to the longitudinal axis of the electrode. The taper may extend less than 40%, 30%, 20%, 15%, 10%, 9%, 8%, 7%, 6%, 5%, 4% or 3% of the length of the electrode. The lower edge of the electrode or edge proximate to the at least one inlet may be tapered on one or more sides, such as two opposed longitudinal sides, more especially one longitudinal side. If the lower edge of the electrode or edge proximate to the at least one inlet is tapered on more than one side, then the taper on each side may be the same or different.

The apparatus may also include at least one non-conductive element positioned within the treatment chamber. The non-conductive element may alter the electrical field (amperage and voltage) within the treatment chamber. The position, shape and configuration of the non-conductive element may be as described above for the electrodes. However, the non-conductive element is made of a material that does not conduct electricity, such as, for example, a material selected from the group consisting of: a polymer plastic (such as polyvinyl chloride (PVC), high density polyethylene (HDPE), low density polyethylene (LDPE), acrylonitrile butadiene styrene (ABS), polypropylene (PP)); a composite material made with a non-conducting fibre or panel (such as fibreglass) mixed with a resin or resin solution (such as a polyester, vinyl ester, epoxy, phenolic, polyimide, polyamide, polypropylene or polyether ether ketone (PEEK)) to produce a polymer matrix, or a combination of the aforementioned materials. In one embodiment the apparatus does not include any non-conductive elements.

The apparatus may further include at least one electrode holder for holding a plurality of electrodes. The treatment chamber may be configured to engage (especially releasably engage) with at least one electrode holder holding a plurality of electrodes for electrochemical treatment of the liquid. In a further embodiment, the apparatus further includes the electrode holder holding the plurality of electrodes, wherein the electrode holder is engageable with the treatment chamber (especially such that the plurality of electrodes are positioned or releasably engaged within the treatment chamber). In one embodiment, the said electrode holder includes a flow aligner for aligning the flow of the liquid between the electrodes, and wherein when the electrode holder is releasably engaged with the treatment chamber said flow aligner is positioned intermediate the at least one inlet and the electrodes.

The at least one electrode holder may be positionable within the treatment chamber. The treatment chamber may include at least one guide for guiding the electrode holder into position. The treatment chamber may include at least one (or a plurality of) grooves for slidable engagement of the electrode holder in the treatment chamber. The treatment chamber may include at least one power connector for connecting power to the electrode holder or to at least one electrode held by the electrode holder. The treatment chamber may include a plurality of power connectors (for example of the same or different polarity) for connecting power to each electrode holder or to electrodes held by the electrode holder.

The treatment chamber may include at least one power connector for connecting power to the electrode holder, to thereby power at least one of the electrodes held by the electrode holder. For each electrode holder, the treatment chamber may include at least one power connector for connecting power to at least one anode in the electrode holder (especially one or two power connectors) and at least one power connector for connecting power to at least one cathode (especially one or two power connectors) in the electrode holder.

In one embodiment, the treatment chamber includes at least one power connector that is adapted to contact the working face of at least one (for example one or two) electrodes. As used herein, the term “working face” refers to the surface of the electrode that contacts the liquid during the electrochemical treatment. In this embodiment, at least one (especially one or two) power connectors may be positioned adjacent one or more side walls of the treatment chamber, especially one or more side walls parallel to the working face of the electrodes. At least one power connector may be positioned between electrode holders in the treatment chamber. At least one power connector may be positioned intermediate two electrode holders, and the at least one power connector may be positioned intermediate to the working face of a terminal electrode of each electrode holder (in this case, one power connector may power one electrode in each electrode holder. In this case, the at least one power connector may be housed within a power connector housing located intermediate two electrode holders). In this embodiment, the at least one power connector may include a biasing mechanism for biasing the power connector against an electrode. The biasing mechanism may include a compression spring. The at least one power connector may be made of a metal, especially a resilient metal, such as steel or titanium, more especially stainless steel, most especially spring steel. Advantageously, the use of a biasing mechanism in the power connector may improve the contact between the electrode and the power connector, assist in holding the electrode holder in place, and avoid the need for screwed connectors when replacing electrode holders. In one embodiment, the power connector may traverse a wall of the treatment chamber (especially a side wall) to provide a tab for connection to a power source (possibly via the current controller, as described further below). The at least one power connector may have or include a corrugated shape.

The treatment chamber may be configured to releasably engage with from 1 to 100 electrode holders, especially from 2 to 50 electrode holders, more especially from 2 to 40, from 2 to 30, from 2 to 20, or from 2 to 10 electrode holders.

Each said electrode holder may include a frame, and the frame may include a handle and at least two side walls. The handles of the electrode holders, once placed in the treatment chamber, may form the lid of the treatment chamber. The electrode holder handles may sealingly abut each other in the treatment chamber. The frame may also include a flow aligner (or a segment of a flow aligner). In one embodiment, the flow aligner is a wall or partition defining a plurality of apertures for passage of the liquid, and wherein the treatment chamber includes a shelf upon which the electrode holder rests when the electrode holder is releasably engaged with the treatment chamber. The frame may be substantially U-shaped, with the base of the “U” forming the handle and the sides of the “U” forming the side walls. Alternatively, the frame may be of substantially square or rectangular-shaped, with two opposite side walls of the square/rectangle forming the side walls of the frame, and the other opposed sides forming a flow aligner and a handle. The electrode holder may be in the form of a cartridge. Accordingly, each said electrode holder (or at least one said electrode holder) may include a flow aligner, as described above. The flow aligner may be positioned between the electrodes and the at least one inlet. The flow aligner may be positioned opposite to the handle, beneath the electrodes. The electrode holder handle may include an electrode holder remover (such as a strap (or strap loop), especially a cable, string or thread) to assist in removing the electrode holder from the treatment chamber.

The electrode holder, especially the at least two side walls of the electrode holder may be configured to releasably engage with the treatment chamber. The electrode holder (especially the at least two side walls) may be slideably engageable with the treatment chamber. The electrode holder (especially the at least two side walls) may be releasably engageable in the treatment chamber by friction, by a clamp, or by another suitable fastener. In another embodiment, the treatment chamber may include a shelf upon which the electrode holder rests when in position.

In one embodiment, the treatment chamber or the electrode holder may include a clamp for releasably clamping the electrode holder in position. The electrode holder (especially at least one of the at least two side walls or the side of the holder proximate to the first wall of the treatment chamber) may be configured to accept power, especially from a wall of the treatment chamber. The electrode holder (especially at least one of the at least two side walls) may be configured to supply power along a longitudinal edge of at least one electrode held by the electrode holder. The treatment chamber may also be configured to provide power longitudinally along the working face of at least one electrode. Providing power along a longitudinal edge of at least one electrode, or longitudinally along the working face of at least one electrode, may provide superior flow of power than if power was only supplied to the at least one electrode at a single point.

The electrode holder may include a power connector for connecting with a power connector from the treatment chamber. If present, power connectors in the electrode holder and the treatment chamber may connect in any suitable way. For example, the two power connectors may connect by way of abutting surfaces or projections, or by way of a male-female connection.

The electrode holder may hold a plurality of electrodes. The electrodes within the electrode holder may be replaceable and/or removable. In one embodiment, the electrodes within the electrode holder may not be replaceable and/or removable. The electrode holder may include slots machined to enable the electrodes to slide in and out of the electrode holder as required. This may enable replacement of the electrodes within the electrode holder whilst the apparatus is in operation. The electrodes, properties of the electrodes, orientation of the electrodes, and the relationship between two electrodes (e.g. the distance between electrodes) in the electrode holder may be as described above. For the avoidance of doubt, the electrode holder may also include at least one non-conductive element. Therefore, the electrode holder may hold one or more electrodes and one or more non-conductive elements.

Any suitable number of electrodes may be held by the electrode holder. In one embodiment, the electrode holder may hold from 3 to 100 electrodes; especially from 3 to 50 electrodes; more especially from 3 to 25 electrodes; most especially from 5 to 15 electrodes or from 8 to 15 electrodes, about 10 electrodes or about 13 electrodes. In one embodiment, the electrode holder holds at least 3, 4, 5, 6, 7, 8, 9 or 10 electrodes. In another embodiment, the electrode holder holds less than 100, 90, 80, 70, 80, 70, 60, 50, 40, 30, 20 or 15 electrodes.

The electrode holder or the electrodes within the electrode holder may be positionable within the treatment chamber at any suitable angle. The orientation of the electrode holder may be as described above for the angle of electrodes within the treatment chamber.

In one embodiment, the electrode holder may be positionable substantially vertically within the treatment chamber. This may be particularly advantageous if the liquid substantially ascends through the treatment chamber. In this embodiment, the electrodes may be held substantially vertically by the electrode holder, or the electrodes may be held at an angle from the vertical by the electrode holder. In another embodiment, the electrode holder is positionable at an angle within the treatment chamber.

The electrodes within the electrode holder may be positionable in the same plane as the electrode holder, or the electrodes may be positionable at an angle relative to the longitudinal plane of the electrode holder. For example, the electrodes may be positionable at an angle of from 0-20 degrees from the longitudinal plane of the electrode holder, more especially from 0-15 degrees or from 0-10 degrees, most especially from 0-5 degrees or 0-3 degrees or 0 degrees from the longitudinal plane of the electrode holder.

The electrode holder advantageously may allow for the easy and rapid exchange of electrodes in the apparatus. The electrode holder may overcome the delays inherent in changing individual electrodes within the reaction chamber and may be particularly advantageous in areas of low head height.

The frame of the electrode holder may be made of any suitable material, but especially may be made of a non-conductive material. The frame of the electrode holder may be made of the materials discussed above for the treatment chamber. The frame of the electrode holder may be especially made from a composite material made with a non-conducting fibre or panel (such as fibreglass) mixed with a resin or resin solution (such as a polyester, vinyl ester, epoxy, phenolic, polyimide, polyamide, polypropylene or polyether ether ketone (PEEK)) to produce a polymer matrix; or a polymer plastic such as high density polyethylene (HDPE), polyethylene (PE), polyethylene terephthalate (PET) or polyvinyl chloride (PVC); a phenolic polymer plastic; or a carbon fibre insulated using a polymer plastic or a composite material.

The electrode holder may be removable from the treatment chamber by way of a removal device (especially a lifting device which lifts the electrode holder from the treatment chamber). In one example, the lifting device may lift the electrode holder substantially vertically before allowing for horizontal movement of the electrode holder above the apparatus. The lifting device may be slideably mounted on at least one (especially two) rails. In one embodiment, the electrode holder may be removable using an overhead gantry.

The apparatus may further include a liquid pump for pumping liquid to be treated through the at least one inlet for entry of a liquid to be treated, and/or at least one treatment agent pump (which may be a liquid pump and/or a gas pump) for pumping the treatment agent through the at least one treatment inlet. Said pump may be a variable speed pump. Any suitable pump may be used. For example, the gas pump may be an entrained air pump or a centrifugal, diaphragm, peristaltic, geared or similar pump. A liquid pump may or may not be necessary, depending on the pressure of the liquid delivered to the treatment chamber. However, a liquid pump, particularly a geared or diaphragm pump, may be advantageous as this may permit greater control over the liquid flow rates within the treatment chamber.

The apparatus may further include one or more sensors for sensing: flow velocity through the treatment chamber; volume of liquid in the treatment chamber (including the liquid height, especially when the liquid substantially ascends through the treatment chamber); formation of products in the treatment chamber or exiting the treatment chamber (including gases, especially explosive gases); presence of contaminants in the treatment chamber or exiting the treatment chamber; passivating accumulations on one or more electrodes; and the conductivity of the liquid in the treatment chamber.

In one embodiment, the apparatus includes a system for regulating the electrochemical treatment. The system may be automated and include one or more sensors as outlined in the preceding paragraph and one or more devices for regulating the electrochemical treatment, wherein the one or more devices are in communication with the one or more sensors to thereby automate the treatment. The system may be controlled by a controller (such as a programmable logic controller (PLC)). The one or more devices may include at least one selected from the group consisting of: a pump (especially a variable speed pump) for regulating the flow of liquid into the treatment chamber; a current controller for controlling the electrical current to the electrodes (especially for controlling the polarity of the current and its reversal to thereby provide cathodes and anodes, and/or the voltage of the current); treatment enhancer applicator for applying a treatment enhancer to the treatment chamber (for example, an electromagnetic radiation source or a sonic generator); a valve for draining the treatment chamber (and optionally a pump in fluid communication with the valve); a treatment agent applicator for applying one or more treatment agents to the treatment chamber (this may include a treatment agent pump); fluid jets (including liquid and gas jets) for reducing passivating accumulations on the electrodes (the fluid jets may be high-pressure fluid jets); an electrode holder remover and inserter; and an electrode plate remover and inserter.

As outlined above, the current controller may control the polarity of the current and its reversal to thereby provide cathodes and anodes. In one embodiment the polarity of the electrodes is reversed during the electrochemical treatment. Any suitable electrical current may be applied to the plurality of electrodes. The polarity of the electrodes may advantageously be alternated to thereby reduce passivating accumulations on the electrodes and create a reversible electrical field within the treatment chamber. The polarity switching of the electrodes may allow specific chemical reactions to be delayed or accelerated as required. During the electrochemical treatment the anodes typically are sacrificial and gradually reduce in size. In contrast the cathodes typically undergo passivation and accumulate matter on their surfaces. By regularly reversing the polarity of the current flowing to the electrodes the same electrode will successively function as a cathode and an anode. In this way the passivating surface of the cathode becomes the eroding surface of the anode, which reduces passivating accumulations on the electrode and slows the reduction in size of the electrode. In one embodiment, the current source applied to the apparatus is direct current, but due to the alternating polarity of the current by the current controller, the current applied to the electrodes is alternating current. In other words, the current applied to the plurality of electrodes may be a direct current of adjustable frequency of alternation. The current controller may also modify the sinewave ramping angles during the electrochemical treatment, and/or modify the rate of current application to the electrodes during the electrochemical treatment. This may reduce electric arcing and generally improve the performance and reliability of key components whilst utilising high current device switching.

Accordingly, the current controller may control the frequency of current reversal to the electrodes. The current controller may also control the relative proportion of cathodes and anodes in the electrochemical apparatus. Control of the relative proportion and hence surface area of cathodes and anodes may be advantageous, as this will alter the chemistry of the electrochemical treatment. For example, if the total surface area of the anodes exceeds (especially by a significant degree) the surface area of the cathodes then an oxidising environment is created within the treatment chamber. Alternatively, if the total surface area of the cathodes exceeds (especially by a significant degree) the surface area of the anodes, then a reducing environment is created within the treatment chamber. The electrical current controller may apply a voltage to the treatment chamber to apply an effective voltage to each cell of from 0.01 to 50 V; especially from 0.1 to 40 V, from 0.1 to 30 V, or from 0.1 to 20 V; more especially from 0.1 to 10 V or from 0.1 to 5 V or from 0.5 to 3 V; most especially from 0.5 to 2 V or from 0.5 to 1.5 V, or about 1.1 V (the “effective voltage to each cell” is the voltage between two adjacent electrodes in the treatment chamber). The electrochemical treatment may be performed at an effective voltage to each cell of from 0.01 to 50 V; especially from 0.1 to 40 V, from 0.1 to 30 V, or from 0.1 to 20 V; more especially from 0.1 to 10 V or from 0.1 to 5 V or from 0.5 to 3 V; most especially from 0.5 to 2 V or from 0.5 to 1.5 V, or about 1.1 V.

The inventors have found that the effective voltage to each cell may be adjusted by adjusting the voltage applied to the electrodes by the electrical current controller, by adjusting the number of electrodes connected to an electrical current, by positioning a non-conductive element within the treatment chamber, and/or by altering the number of electrodes in the treatment chamber (for example using an electrode holder remover and inserter, and/or an electrode plate remover and inserter) The electrical current may be provided by a voltage source. In one embodiment, the apparatus further includes a voltage source. The conductivity of the liquid in the treatment chamber may vary, and this conductivity may affect the extent and type of reactions occurring in the treatment chamber during the electrochemical treatment. For example, the electrochemical treatment may provide the same (or similar) effect when treating a highly conductive liquid with fewer electrodes, as when treating a poorly conductive liquid with a greater number of electrodes. A sensor for sensing the conductivity of the liquid in the treatment chamber may be in communication (such as via a PLC) with the current controller, an electrode holder remover and inserter, and/or an electrode plate remover and inserter to thereby control the effective voltage to each cell and/or simultaneously control the surface area of both anodes and cathodes and hence the overall cell resistance or impedance (this may occur in an automated manner).

Any of the features described herein can be combined in any combination with any one or more of the other features described herein within the scope of the invention.

### BRIEF DESCRIPTION OF DRAWINGS

Various embodiments of the invention will be described with reference to the following drawings, in which:

FIG. 1 is a top view of the layout of a trailer including an exemplary water treatment system including an electrochemical liquid treatment apparatus (HEC20016);

FIG. 2 is a top view of the electrochemical liquid treatment apparatus in the system of FIG. 1;

FIG. 3 is a side view of the electrochemical liquid treatment apparatus of FIG. 2;

FIG. 4 is a perspective view of the electrochemical liquid treatment apparatus of FIG. 2;

FIG. 5 is a perspective view of an example electrode holder;

FIG. 6 is an exploded perspective view of the electrode holder of FIG. 5;

FIG. 7 is a perspective view of a first example electrochemical liquid treatment apparatus;

FIG. 8 is cross sectional view of the apparatus of FIG. 7, through the liquid entry point and defoaming chamber outlet;

FIG. 9 is a cross sectional view of the apparatus of FIG. 7, through the treatment chamber;

FIG. 10 is a perspective view of the electrode holder in the apparatus of FIG. 7;

FIG. 11 is a bottom perspective view of the electrode holder of FIG. 10;

FIG. 12 is a cross sectional view through the electrode holder of FIG. 10;

FIG. 13 is a top perspective view of the treatment chamber and defoaming chamber in the apparatus of FIG. 7;

FIG. 14 is a perspective view of the treatment chamber and defoaming chamber of FIG. 13;

FIG. 15 is a cross sectional view through the treatment chamber of FIG. 13;

FIG. 16 is a perspective view of the apparatus of FIG. 13 with the electrode holder partly removed; and

FIG. 17 is a cross sectional view through the treatment chamber and electrode holder of FIG. 13 with the electrode holder partly removed;

FIG. 18 is a perspective view of a second example electrochemical liquid treatment apparatus;

FIG. 19 is a cross sectional view of the apparatus of FIG. 18;

FIG. 20 is an exploded perspective view of the apparatus of FIG. 18;

FIG. 21 is a side cross sectional view of the apparatus of FIG. 18 with a foam collector;

FIG. 22 is a top view of the apparatus of FIG. 21; and

FIG. 23 is a side view of an exemplary foam mover.

Preferred features, embodiments and variations of the invention may be discerned from the following Examples which provides sufficient information for those skilled in the art to perform the invention. The following Examples are not to be regarded as limiting the scope of the preceding Summary of the Invention in any way.

### EXAMPLES

### Exemplary Electrochemical Apparatuses

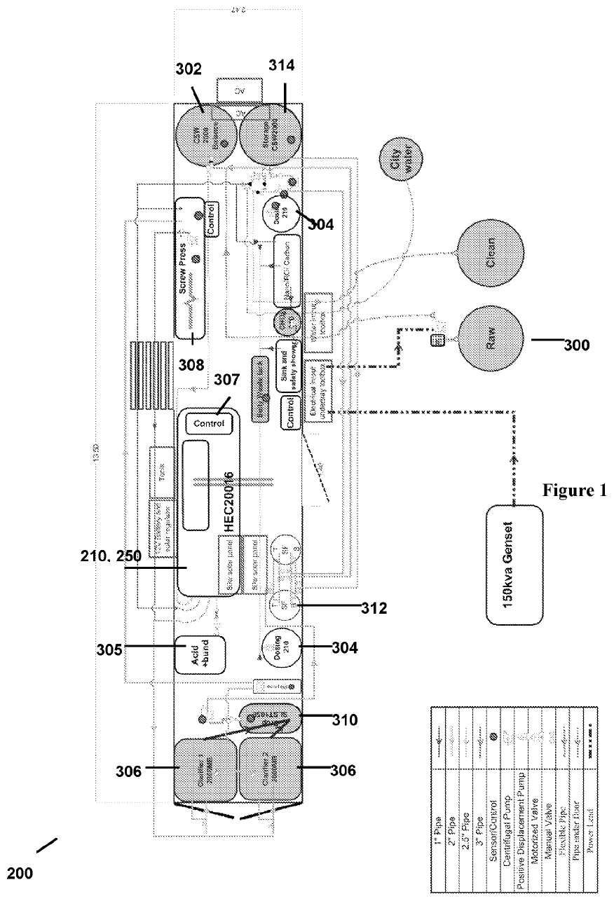

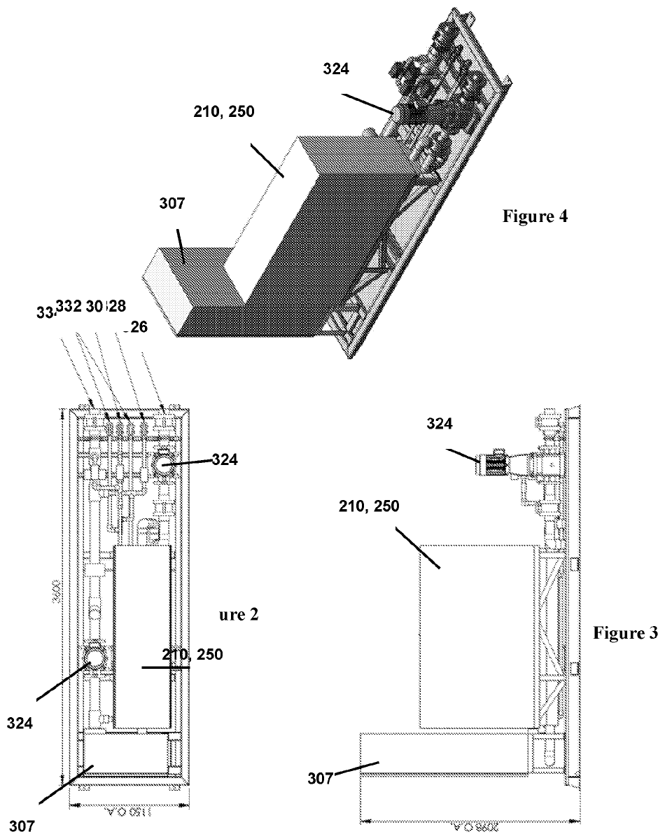

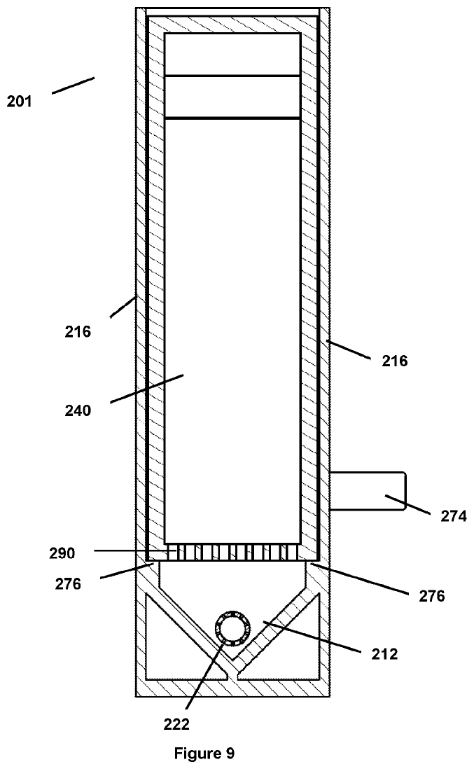

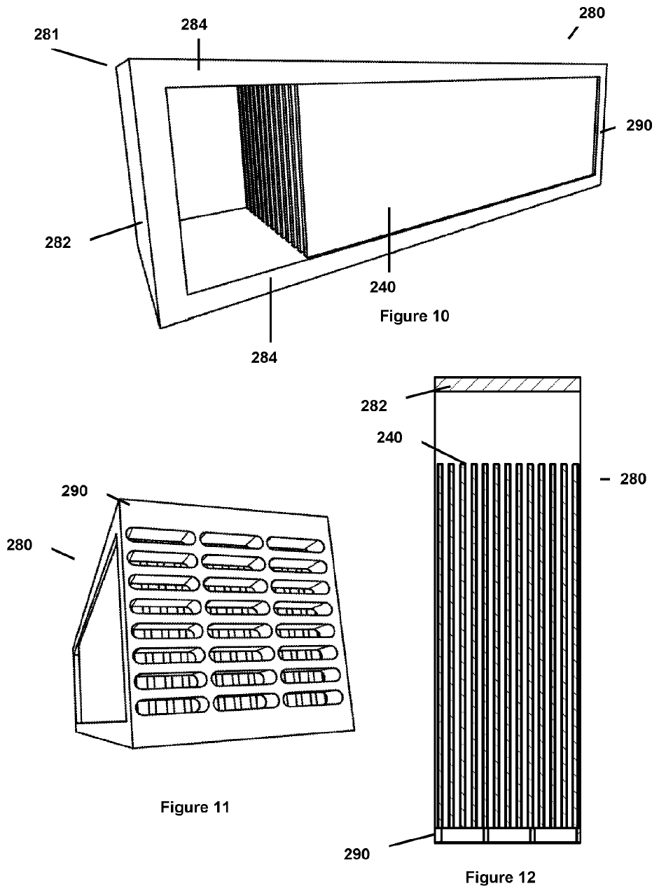

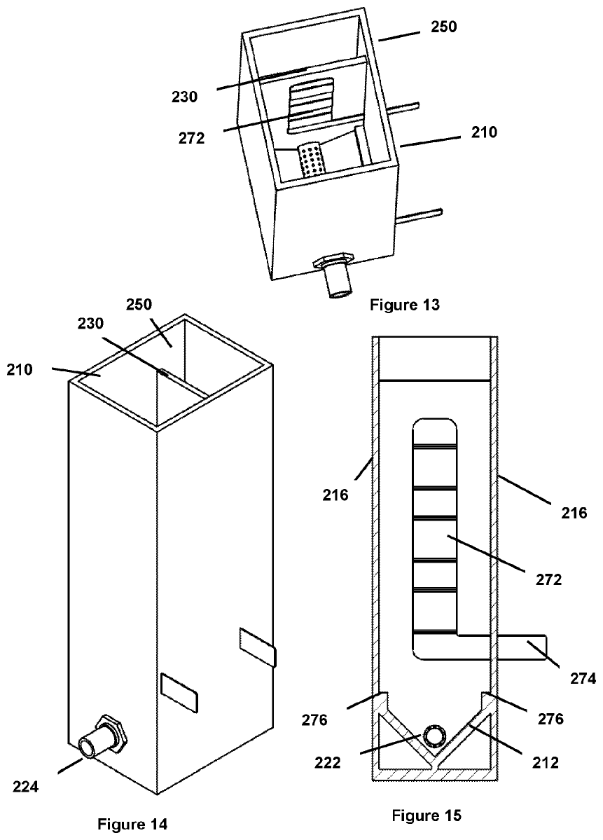

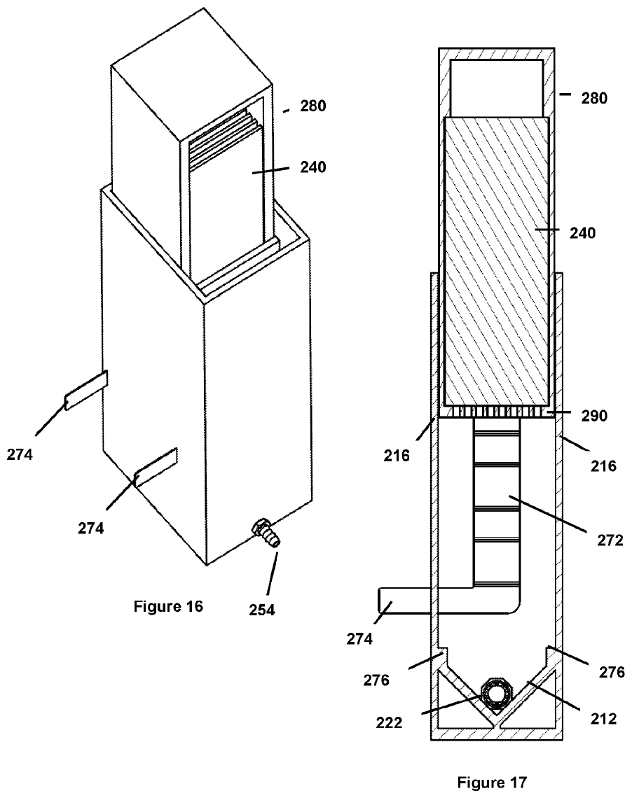

Embodiments of the invention will now be described with reference to FIGS. 1 to 23 and the following section describing the methods. In the figures, like reference numerals refer to like features.

FIGS. 1 to 4 describe a water treatment system 200 and components thereof in the form of a trailer. FIGS. 1 to 4 illustrate a water treatment system 200 including an electrochemical liquid treatment apparatus 201. In FIG. 1, the treatment chamber 210 and defoaming chamber 250 are provided within the component labelled HEC20016 (this component is illustrated, for example, in FIGS. 2-4 and 18-22).

As shown in FIG. 1, raw water 300 external to the trailer is supplied to a balance tank 302 using a centrifugal pump. At least one treatment agent (stored in a dosing tank 304) may be added to the water flowing to the balance tank 302 using a positive displacement pump.

The water then flows to the treatment chamber 210 where electrochemical treatment occurs. The pH of the liquid during the electrochemical treatment may be controlled by the introduction of an acid from acid tank 305. The electrochemically treated water then flows to the defoaming chamber 250, and the foam to a foam separation vessel. The electrochemical process may be controlled via a system for regulating the electrochemical treatment (which includes a controller (PLC) 307). Electrochemically treated water then flows to clarifiers 306 (which have a level switch).

Clarified water (and floc) may exit the clarifiers 306 before passing through a positive displacement pump to a drain connection. Alternatively, the clarified water (and floc) from the clarifiers 306 may pass to a screw press 308 having a float valve. Pressed or substantially dewatered floc exits the screw press to a waste bin. Liquid exiting the screw press 306 passes to centrifugal pump, and then passes back to clarifiers 306.

Clarified water may be passed from clarifiers 306 to a drop tank 310. Fluid exiting drop tank 310 passes through a centrifugal pump and then to sand filters 312 (for separation of floc from the water) or optionally back through clarifiers 306. After sand filtration the water may be passed to a storage tank 314 (where is it optionally treated by a treatment agent (stored in a dosing tank 304, in which the treatment agent may be pumped into the storage tank 314 by way of a positive displacement pump)). From storage tank 314 the treated water may be released. Alternatively, water from the storage tank 314 may pass to: (i) further components of a filtration and/or polishing system, such as a carbon filter or similar fluorocarbon adsorbant material, nanofilter or ion exchange resin, and/or reverse osmosis system; (ii) screw press 308; or (iii) treatment chamber 210 and defoaming chamber 250. The filtered water may pass to a storage tank before re-electrochemical treatment or disposal. In FIG. 1, the electrochemical liquid treatment apparatus 201 includes balance tank 302, acid tank 305, dosing tank 304, treatment chamber 210, defoaming chamber 250, and clarifiers 306. As illustrated in FIGS. 1 to 4, there are various pumps 324 and valves associated with the system 200 and apparatus 201.

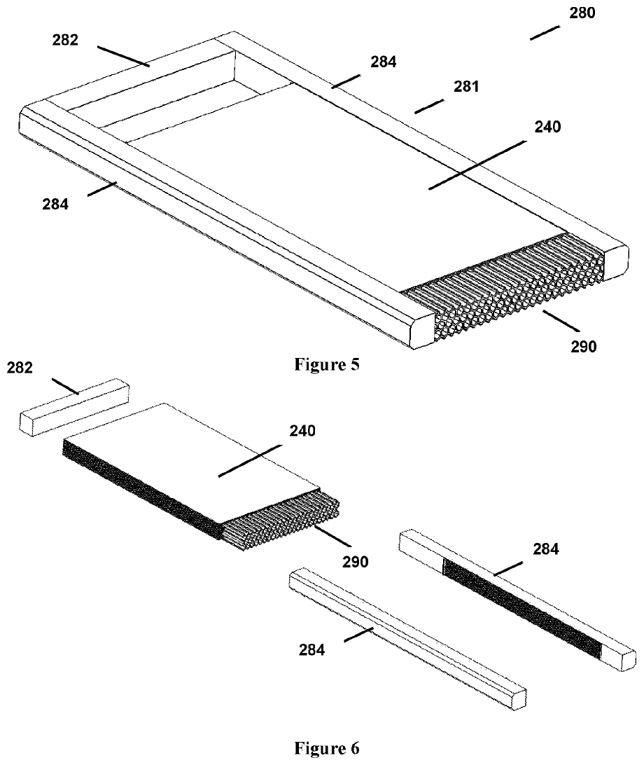

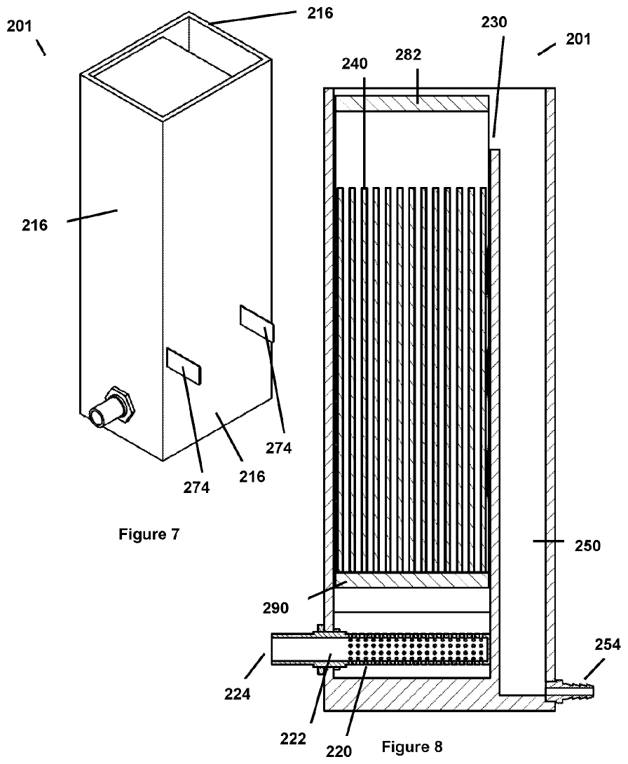

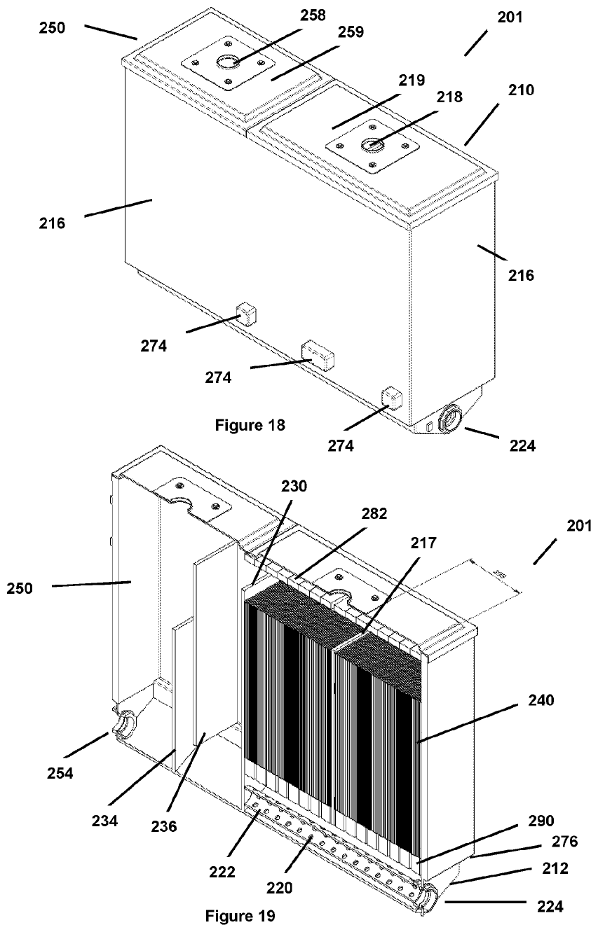

Two example treatment chambers 210, electrode holders 280, and defoaming chambers 250 are illustrated in FIGS. 5 to 22; a first at FIGS. 7-17, and a second at FIGS. 5, 6 and 18-22. The treatment chamber 210 illustrated in FIGS. 7-9 and 13-17 is capable of only accommodating one electrode holder 280. The treatment chamber 210 illustrated in FIGS. 18-22 is capable of accommodating 16 electrode holders 280. The electrode holders 280 illustrated in FIGS. 18-22 is capable of holding 10 electrodes 240 (as shown in FIGS. 5 and 6), whereas the electrode holder 280 illustrated in FIGS. 7-12, 16 and 17 is capable of holding 13 electrodes 240. The treatment chamber 210, defoaming chamber 250 and electrode holders 280 in the treatment system 200 illustrated in FIGS. 1-4 is of similar design to those in FIGS. 5-22. However, in the treatment system 200 of FIGS. 1-4, the treatment chamber 210 is capable of accommodating 400 electrodes (which equates to between 30 and 40 electrode holders 280) or the treatment chamber 210 is capable of accommodating 160 electrodes (equating to 16 electrode holders 280). In one embodiment, the treatment chamber 210, defoaming chamber 250 and electrode holders 280 in the treatment system 200 illustrated in FIGS. 1-4 is the treatment chamber 210, defoaming chamber 250 and electrode holders 280 illustrated in FIGS. 18-22.

The treatment chamber 210 in the apparatus 201 of FIGS. 1-4 and 18-22 is about 500 L, and can accept a liquid flow rate of about 14 L/second. The residence time of the liquid in the treatment chamber 210 in the apparatus 201 of FIGS. 1-4 and 18-22 is typically about 30 s.

The treatment chamber 210 in FIGS. 7-9 and 14-17 is about 1 L, and can accept a liquid flow rate of about 2 L/minute. The residence time of the liquid in the treatment chamber 210 of FIGS. 7-9 and 13-17 is typically about 30 s.

The apparatuses 201 illustrated in FIGS. 1-17 are configured to operate at atmospheric temperature and pressure. The apparatus 201 illustrated in FIGS. 18-22 may be configured to operate at atmospheric temperature and pressure, or at reduced or elevated pressures (by applying suction or pressure at ports 218 and 258).

In the examples of FIGS. 1-22, the apparatus 201 is configured so that the liquid rises (or ascends) as it passes through the treatment chamber 210. As illustrated in FIGS. 7-9 and 13-22, the treatment chamber 210 includes a base 212 (or first wall), and four side walls 216.

In FIGS. 7-9 and 13-17 the treatment chamber does not include a second wall (or lid), although a lid may be formed by the handle(s) of the electrode holders 280 (see FIGS. 7 and 8 for example). However, in FIGS. 18-22 the treatment chamber 210 and defoaming chamber 250 include a lid 219, 259. The lids 219, 259 include ports 218, 258 as discussed above. The ports 218, 258 may be for extracting gas.

The treatment chambers 210 in FIGS. 7-22 are generally of substantially rectangular (or square) cross section. Each side wall 216 is planar. However, the bases 212 include a trough or channel and are substantially V-shaped.

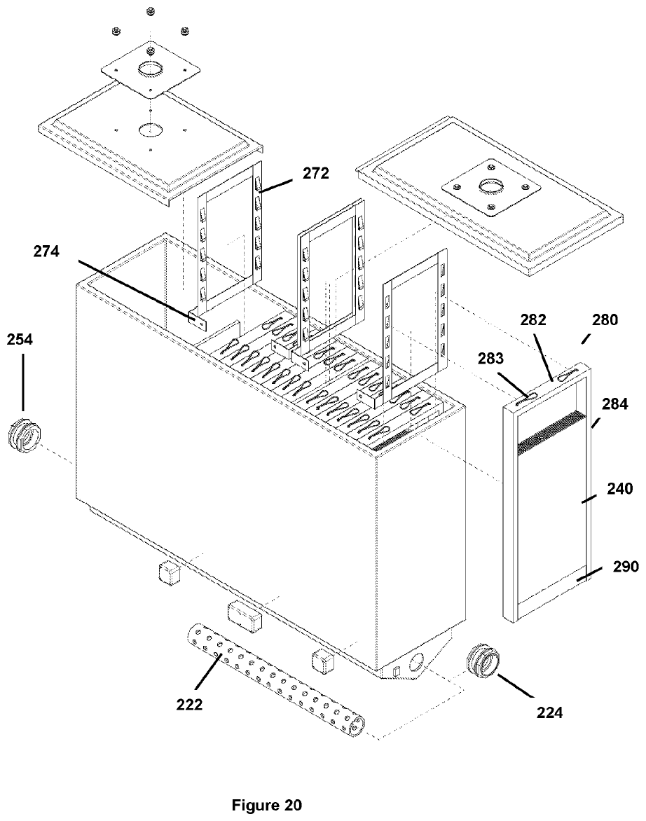

The treatment chambers 210 include a disperser 222, and the disperser 222 includes a tube with one liquid entry point 224 and a plurality of inlets 220. The disperser 222 illustrated in the apparatuses 201 of FIGS. 7-22 is a tube perforated along its length to provide a plurality of inlets 220 into the treatment chamber 210 (see FIGS. 8 and 20 in particular). The disperser 222 is positioned within the trough or channel in the base 212.

The apparatuses 201 further include a flow aligner 290. The flow aligner 290 is connected to the electrode holders 280 (see FIGS. 5, 6, 10-12, 19 and 20). The flow aligner 290 is in the form of a wall or partition defining a plurality of apertures for passage of the liquid. In use, liquid flows (or is pumped) through the inlets 220 into the lower portion of the treatment chamber 210. The rate at which the liquid flows through the inlets 220 is set so that the liquid pressure on the side of the flow aligner 290 proximate to the at least one inlet is greater than the liquid pressure on the side of the flow aligner 290 proximate to the electrodes 240. The inventors have advantageously found that the combination of the pressure differential across the flow aligner 290 and the consistently spaced and sized apertures across the flow aligner 290 provides an even flow of liquid between the electrodes 240, minimising so-called “dead spots” in between the electrodes 240 and thereby improving the service life of the electrodes, particularly sacrificial anodes and hence downtime associated with having to change electrodes.

The flow aligner 290 in the apparatuses 201 of FIGS. 1-6 and 18-20 is segmented (with one segment per electrode holder 280). When the electrode holders 280 are in position in the treatment chamber 210, each flow aligner 290 segment is in close proximity with the adjoining segment, so that the electrode holders 280 collectively form the flow aligner 290.

The flow aligner 290 in FIGS. 5, 6 and 18-20 have polygonal (hexagonal) apertures, and the flow aligner 290 in FIGS. 7 to 12, 16 and 17 have ovoid apertures.

The apparatus 201 may be configured to electrochemically treat the liquid in the presence of at least one treatment enhancer or at least one treatment agent. The at least one treatment enhancer is capable of penetrating a solid wall of the treatment chamber, and consequently the at least one treatment enhancer (such as ultraviolet radiation, microwave radiation or ultrasonic waves) may be applied to a side wall 216 of the treatment chamber 210. The at least one treatment agent may enter the treatment chamber 210 through at least one treatment inlet, such as through a gas inlet. The gas inlets may be part of a gas disperser, which may be integral with the base of the treatment chamber 210. The types and function of such gases may be as previously described. Alternatively, the at least one treatment inlet may be mixed with the liquid to be treated before the liquid enters the treatment chamber 210. As illustrated and discussed with reference to FIG. 1, in the illustrated system 200 the dosing tank 304 may include a treatment agent which is mixed with the liquid in balance tank 302 before the liquid enters the treatment chamber. Also, at least one treatment agent may be added to the liquid entering the storage tank 314 after electrochemical treatment from dosing tank 304. Furthermore, in FIG. 1 at least one treatment agent (in the form of a pH modifier (an acid)) may be added to the treatment chamber 210 during the electrochemical treatment from acid tank 305.

The treatment chamber 210 also includes at least one outlet 230 for exit of electrochemically treated liquid. In the apparatuses 201 of FIGS. 7-9 and 13-22 the at least one outlet 230 is one outlet. As shown in FIGS. 8 and 19, in these apparatuses 201 the outlet 230 is positioned so that the electrodes 240 are configured to be positioned intermediate the at least one inlet 220, and the at least one outlet 230, and the at least one inlet 220 is positioned in a lower portion of the treatment chamber 210 and the at least one outlet 230 is positioned in an upper portion of the treatment chamber 230.

In the apparatuses 201 of FIGS. 7-9 and 13-22 the at least one outlet 230 is in the form of a weir or spillway. The outlet 230 is positioned at the intended height of liquid in the treatment chamber 210. In the apparatuses 201 of FIGS. 7-9 and 13-22, after exiting the treatment chamber 210 at outlet 230, the liquid passes to a defoaming chamber 250.

In the apparatus 201 of FIGS. 7-9 and 27-30, after flowing through outlet 230, the liquid descends through defoaming chamber 250 and then through an outlet 254 at the base of the chamber 250.

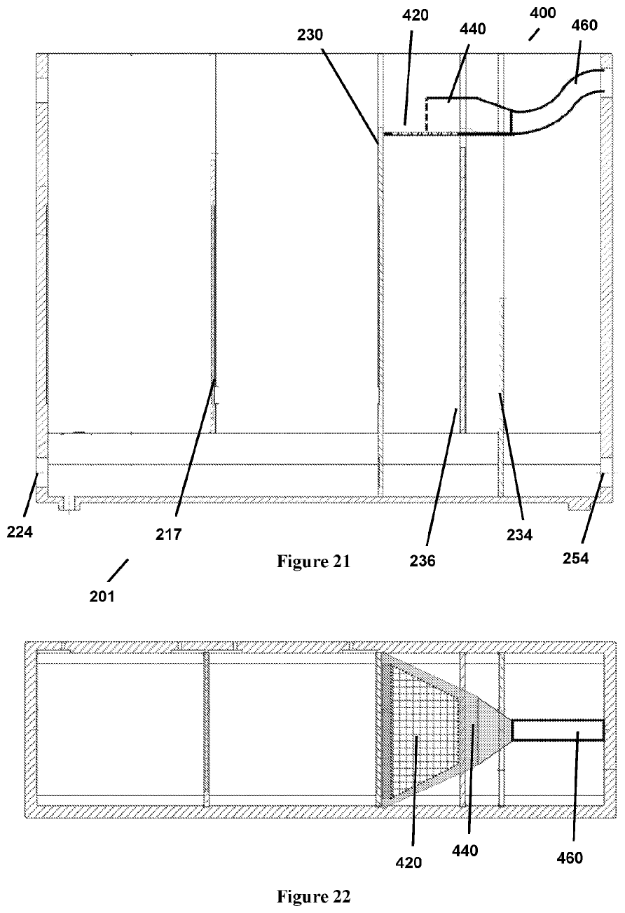

In the apparatus 201 of FIGS. 18-22, the defoaming chamber 250 includes a first flow diverter 234 and a second flow diverter 236. The first flow diverter 234 provides a weir inside the defoaming chamber 250. The second flow diverter 236 provides an underflow weir (under which fluid passes when flowing through the defoaming chamber 250). The bottom of the second flow diverter 236 extends below than the top of the first flow diverter 234. Both the first and second flow diverters 234, 236 are substantially vertical and are in the form of a wall or plate. In the arrangement illustrated in FIG. 19, electrochemically treated fluid exits the treatment chamber 210 through outlet 230. As shown in FIGS. 21 and 22, the apparatus of FIGS. 18-22 is fitted with a foam collector 400 (foam collector not shown in FIGS. 18-20). The foam collector 400 includes a filter 420. The filter 420 may be in the form of a mesh, especially so-called ‘20 mesh’ stainless steel mesh (where the mesh contains 20 apertures to each lineal inch (25.4 mm)). The filter 420 of the foam collector 400 is in register with the outlet 230. The filter 420 forms part of vacuum nozzle 440, which extends to a hose 460, which is then connected to a partial vacuum source (such as a pump). The upper wall of the nozzle 440 does not extend as far as the outlet 230 to assist in drawing the foam into the foam collector 400. The vacuum source sucks collected foam to an intermediate vessel for settling. Preferably, the vessel is at a negative pressure to assist defoaming. In use, foam generated in the electrochemical treatment forms on top of the liquid in the treatment chamber 210. The foam is driven towards the outlet 230 and foam collector 400 by virtue of the flow rate of liquid through the apparatus 201. Once the foam and liquid reach the outlet 230, the foam does not pass through the filter 420, and instead moves across the filter into nozzle 440 and then into hose 460. The treated liquid (with entrained, but not yet fully formed floc) passes through the filter 440 and then into defoaming chamber 250. The fluid falls into the space between the second flow diverter 236 and the outlet 230, and in use fluid fills this space to at least the height of the first flow diverter 234. As any foam passing through the filter floats, the foam is trapped in this space, and the fluid falling into this space from outlet 230 penetrates the foam to thereby release trapped gas. Meanwhile, defoamed fluid passes beneath the second flow diverter 236 and then over the first flow diverter 234 before exiting the defoaming chamber 250 through outlet 254.

In FIG. 1, after exiting the defoaming chamber 250 the liquid flows to a vessel for separation of the floc from the liquid (clarifier 306).

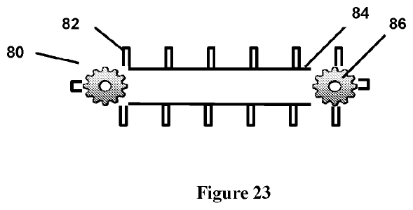

A foam mover 80 (as illustrated in FIG. 23) may be used with the vessel (or clarifier 306) to assist in separating the foam, for example. The foam mover 80 may be positioned at the surface of the liquid above the electrodes in the treatment chamber 210. The foam mover may especially in the form of a foam skimmer for moving foam, especially on the surface of the liquid in the treatment chamber 210. The foam mover 80 may be configured to advantageously move the foam towards filter 400 (as shown in FIGS. 21 and 22), and may assist in providing a horizontal flow for the liquid at the top of the treatment chamber 210, especially on the surface of the liquid in the treatment chamber 210. The foam mover 80 may be positioned substantially above or below the surface of the liquid in the treatment chamber 210, especially at or near the surface of the liquid. The exemplary foam mover 80 illustrated in FIG. 23 includes a plurality of floc paddles or drivers 82 mounted to a belt, strap, chain or cable 84, which is turned by wheels 86. As the wheels 86 turn, floc rising to the surface of the liquid is skimmed and moved towards the filter 400.

In the apparatuses of FIGS. 1-22, the electrodes 240 are added or removed from the treatment chamber 210 via electrode holders 280. In the apparatus 201 of FIGS. 18-22 no such grooves 270 are present. In the apparatuses 201 of FIGS. 7-9 and 13-22 the treatment chamber 210 also includes a shelf 276 upon which the electrode holders 280 rest when in position.

Within each electrode holder 280 only two or three electrodes 240 may be connected to power (and thereby become anodes and cathodes). The remaining electrodes may all be electrical conductors. In each electrode holder 280 each electrode 240 is substantially planar and is of solid construction. The electrodes 240 may have a tapered lower edge, as previously described. The apparatuses 201 of FIGS. 1-22 are configured so that the electrodes 240 are positionable below the level of the liquid in the treatment chamber 210. The apparatuses 201 of FIGS. 1-22 are configured so that the electrodes 240 are positioned substantially vertically (substantially in a plane perpendicular to the first wall 212) within the treatment chamber 210 (although it may also be advantageous to position the electrodes 240 (or a portion of the electrodes) at an angle as previously described).

As illustrated in FIGS. 5, 6, 10-25 and 20, the electrode holder 280 includes a frame 281, and the frame 281 includes a handle 282 and two side walls 284. The frame 281 is substantially “U” shaped. The frame also includes a flow aligner 290 (or a segment thereof).

The treatment chamber 210 of FIGS. 2-4, 7-9, and 16-22 further includes at least one power connector 272 for connecting power to an electrode holder 280 or to at least one electrode 240 held by the electrode holder 280. In FIGS. 7-9 and 13-17, the treatment chamber 210 is configured to supply power longitudinally along the working face of at least one electrode 240. In this example, the power connector 272 is adapted to contact the working face of at least one electrode 240. The power connector 272 includes a partially flexible, corrugated metallic (for example stainless steel or titanium alloy) strip held under tension against the external two electrodes in the electrode holder. In this example, the power connector 272 also traverses the wall of the treatment chamber 210 to provide a tab 274 for connection to a power source. A similar arrangement may be used with a plurality of electrode holders 280 (such as in the treatment chamber 210 of FIGS. 1-4), as in this case each power connector 272 may be positioned intermediate to the working face of a terminal electrode 240 held by two electrode holders 280. The crests (and troughs) of the power connector 272 may be positioned so that the crests of the power connector 272 are held under sufficient tension to contact one terminal electrode 240, and the troughs of the power connector 272 contact the other terminal electrode 240.

A similar mechanism for connecting power to the electrodes 240 is illustrated in the treatment chamber 210 of FIGS. 18-22. In FIGS. 18-22 the treatment chamber 210 is also configured to supply power longitudinally along the working face of at least one electrode 240. However, while the power connector 272 illustrated in FIGS. 7-9 and 14-17 includes one corrugated metallic spring strip per electrode 240, in FIGS. 18-22 the power connector 272 includes two corrugated metallic spring strips per electrode 240 (see FIG. 20). The treatment chamber 210 in the apparatus 201 of FIGS. 18-22 includes four power connectors 272, and each power connector provides power to only one electrode 240.

In FIGS. 5, 6, 7-12 and 16-20, the electrodes 240 are, on average, 3 mm thick and 3 mm apart. However, alternative thicknesses and distances may also be used in the apparatus 201.

In the apparatus 201 of FIGS. 20-22 and 26-30 two of the 13 electrodes 240 (or about 15% of the electrodes 240) are connected to power. The remaining nine electrodes 240 are all electrical conductors.

In the apparatus 201 of FIGS. 18-22, four of the 160 electrodes 240 (or about 2.5% of the electrodes 240) are connected to power. The remaining 156 electrodes 240 are all electrical conductors.

The treatment chamber 210 in FIGS. 18-22 also includes a divider wall (or plate) 217 positionable between the electrode holders 280. The electrode holders 280 in FIGS. 18 and 20 also include an electrode holder remover 283 (in the form of a cable loop or chemically resistant rope) to assist in removing the electrode holder 280 from the treatment chamber 210.

As illustrated in FIGS. 2-4, the apparatus 201 may further include a liquid pump 324 for pumping liquid to be treated through the at least one inlet for entry of a liquid to be treated, and a further pump 324 for pumping liquid from the defoaming chamber 250 (see FIG. 2). In FIG. 2, 326 is a treated water outlet (DN80), 328 is a fresh water inlet (DN25), 330 is a clean-in-place connection (DN25), 332 is a drain outlet (DN25) and 334 is a raw water inlet (DN80). The power supply to the apparatus 201 of FIGS. 2-4 is 415 V, 50 Hz and 150 A.

The apparatus 201 of FIGS. 1-4 further includes sensors for sensing the level of liquid in the treatment chamber 210, and a variable speed pump 324 to control the flow rate of liquid exiting the treatment chamber 210. The sensors and variable speed pump 324 may form part of a system for regulating the electrochemical treatment, which may be controlled by controller (PLC) 307. The controller 307 may control the polarity of the current and its reversal to thereby switch the electrodes 240 between anodes and cathodes. The controller 307 may also control the sinewave ramping angles during the electrochemical treatment, and/or modify the rate of current application to the electrodes 240 during the electrochemical treatment. Similar components may be used in the apparatuses 201 discussed in FIGS. 7-22.

Any suitable current may be applied to the electrodes 240 during the electrochemical treatment, however the voltage applied to each electrode holder 280 in the treatment chamber 210 is typically from 1.1 to 3 V per cell, especially at least 1.1 V per cell.

In use, liquid is pumped into the treatment chamber 210 via the at least one inlet 220, and liquid pressure builds beneath flow aligner 290. Liquid passes through the flow aligner 290 and between the electrodes 240 where the liquid is electrochemically treated and floc and foam is generated. The foam floats on the surface of the electrochemically treated liquid, and the floc typically remains entrained in the liquid (in view of the residence time). The floc, foam and electrochemically treated liquid then pass through the at least one outlet 230 and into the foam collector 400, where the foam passes into hose 460, and floc and liquid pass through the filter 420 into defoaming chamber 250. The floc and liquid pass over/around flow diverter(s) 232 and optionally past defoamers 252. This process leads to defoaming of the floc/electrochemically treated liquid. The floc/electrochemically treated liquid then flows out the outlet 254 in the defoaming chamber 250 and then to a vessel for separation of the floc (e.g. clarifier 306).

### Electrochemical Treatments

In examples 1 and 2 landfill leachate from Minnesota, USA was treated. In both examples, the ammonia was first significantly removed or depleted from the leachate. This step was taken as otherwise organofluoro sulfonic amides can form if excess ammonia is present. Such sulfonic amides may not pass into the foam during the electrochemical treatment as readily as other organofluorine substances.

Ammonia was depleted or removed from the leachate in one of two ways. A first way was to add magnesium chloride and sodium phosphate to the leachate. With stirring, substantially water insoluble struvite (comprising predominantly magnesium ammonium phosphate) forms from the ammonia. The struvite may then be either settled or filtered.

A second way is to air and/or air entrained steam strip the ammonia from the leachate. For example, the pH was raised to about 11.5 (so that ammonia is more likely to be present in the form of ammonia (NH₃) gas than the more stable ammonium ion (NH₄⁺)). Then the leachate is heated to about 150° F. (about 65° C.) to deplete the ammonia. An exemplary heating mechanism is to utilize the latent heat of partially condensing steam in air, blown through the liquid. The pH of the resultant, substantially ammonia free liquid was then reduced to about 7.5 by acidulation.

In Example 1 below, the struvite precipitation method was used. In Example 2 below, the air stripping method was used.

### Example 1

The ammonia depleted leachate was subjected to electrochemical treatment using the apparatus of FIGS. 7-17, which has 13 electrode plates to provide 12 active cells. The electrochemical treatment was performed with a cell residence time of 45 seconds, a flow rate of 0.7 litres per minute, using mild carbon steel electrodes. The distance between electrodes was 3 mm, and the voltage applied was 1.1 volts per cell (one cell is the space between two adjoining electrodes). Electrode polarity was reversed every 30 seconds to avoid cathode passivation. The temperature of the liquid being treated was near ambient temperature (around 25-30° C.). No gases or other treatment agents were used during the electrochemical treatment.

Foam was produced during the electrochemical treatment. Without wishing to be bound by theory, it is believed that foam production was enhanced by the production of hydrogen gas at the sacrificial electrodes during the electrochemical treatment. After production, the hydrogen gas becomes entrained with the organofluorines, producing foam. The foam settled on the surface of the liquid in the treatment chamber 210. The foam was collected using a syringe and then allowed to de-gas in a separate vessel for collection.

The treated water was collected. Given the residence time and flow rate of the electrochemical treatment, floc did not settle on the base of the treatment chamber 210, and there was insufficient time for significant quantities of floc to settle on the surface of the liquid in the treatment chamber 210. Consequently, the treated water included floc. Polymer was added to separate the floc (Flopam AN 905 SH (an anionic polyacrylamide), produced by SNF, USA). A sample of the treated liquid (supernatant treated water) was collected.

Samples of the raw leachate, the foam, and the treated liquid were analysed by ALS, Kelso, Wash. Each sample was homogenized prior to assessment by LC MS MS MS. The results are provided in Tables 1-6.

TABLE 1
Organofluorine Acronyms

| | | | Carbon |
|---|---|---|---|
| Analyte | | | chain |
| Acronym | Chemical Name | Formula | Length |
| PFBS | Perfluorobutane sulfonate | C₄F₉SO₃⁻ | 4 |
| PFHxS | Perfluorohexane sulfonate | C₆F₁₃SO₃⁻ | 6 |
| PFOS | Perfluorooctane sulfonate | C₈F₁₇SO₃⁻ | 8 |
| PFBA | Perfluorobutanoate | F₃F₇CO₂⁻ | 4 |
| PFPeA | Perfluoropentanoate | C₄F₉CO₂⁻ | 5 |
| PFHxA | Perfluorohexanoate | C₅F₁₁CO₂⁻ | 6 |
| PFHpA | Perfluoroheptanoate | C₆F₁₃CO₂⁻ | 7 |
| PFOA | Perfluorooctanoate | C₇F₁₅CO₂⁻ | 8 |
| PFNA | Perfluorononanoate | C₈F₁₇CO₂⁻ | 9 |
| PFDA | Perfluorodecanoate | C₉F₁₉CO₂⁻ | 10 |
| PFUnDA | Perfluoroundecanoate | C₁₀F₂₁CO₂⁻ | 11 |
| PFDoDA | Perfluorododecanoate | F₁₁F₂₃CO₂⁻ | 12 |
| PFTrDA | Perfluorotridecanoate | C₁₂F₂₅CO₂⁻ | 13 |
| FOSA | Perfluorooctane sulfonamide | C₈F₁₇SO₂NH₂ | 8 |
| 62FTS | 1H,1H,2H,2H- | C₆F₁₃CH₂CH₂SO₃⁻ | 8 |
| | Perfluorooctanesulfonic acid | | |
| 82FTS | 1H,1H,2H,2H- | C₈F₁₇CH₂CH₂SO₃⁻ | 10 |
| | Perfluorodecanesulfonic acid | | |

TABLE 2
Analysis results for Organofluorine Concentrations Before and After Treatment - Full Data

| | | | | | | | | | Supernatant |
|---|---|---|---|---|---|---|---|---|---|
| | | Supernatant | | | | | | | removal |
| | | treated | | Ratio of | Foam/ | | | Removal | vs foam |
| | Raw water | water | Foam | foam conc. | Supernatant | Removal | Removal | efficiency | enhanced |
| Analyte | (ng/L) | (ng/L) | (ng/L) | to raw conc. | ratio | ng/L | fraction | (%) | removal |
| PFBS | 1,400.0 | 1,000.0 | 2,300.0 | 1.64 | 2.30 | 400.0 | 0.286 | 28.6% | 0.31 |
| PFHxS | 400.0 | 130.0 | 2,800.0 | 7.00 | 21.54 | 270.0 | 0.675 | 67.5% | 0.10 |
| PFOS | 330.0 | 120.0 | 620.0 | 1.88 | 5.17 | 210.0 | 0.636 | 63.6% | 0.42 |
| PFBA | 1,300.0 | 990.0 | 1,800.0 | 1.38 | 1.82 | 310.0 | 0.238 | 23.8% | 0.38 |
| PFPeA | 1,400.0 | 930.0 | 1,800.0 | 1.29 | 1.94 | 470.0 | 0.336 | 33.6% | 0.54 |
| PFHxA | 3,700.0 | 2,500.0 | 6,700.0 | 1.81 | 2.68 | 1,200.0 | 0.324 | 32.4% | 0.29 |
| PFHpA | 640.0 | 260.0 | 3,400.0 | 5.31 | 13.08 | 380.0 | 0.594 | 59.4% | 0.12 |
| PFOA | 970.0 | 210.0 | 8,400.0 | 8.66 | 40.00 | 760.0 | 0.784 | 78.4% | 0.09 |
| PENA | 42.0 | 4.6 | 340.0 | 8.10 | 73.91 | 37.4 | 0.890 | 89.0% | 0.11 |
| PFDA | 10.0 | 2.3 | 54.0 | 5.40 | 23.48 | 7.7 | 0.770 | 77.0% | 0.15 |
| PFUnDA | 2.3 | 1.2 | 4.2 | 1.83 | 3.50 | 1.1 | 0.478 | 47.8% | 0.37 |
| PFDoDA | 2.1 | 0.7 | 2.0 | 0.95 | 2.70 | 1.4 | 0.648 | 64.8% | 1.08 |
| PFTrDA | 2.7 | 0.9 | 2.0 | 0.74 | 2.30 | 1.8 | 0.678 | 67.8% | 1.62 |
| FOSA | 7.5 | 0.7 | 57.0 | 7.60 | 81.43 | 6.8 | 0.907 | 90.7% | 0.12 |
| 62FTS | 370.0 | 110.0 | 2,100.0 | 5.68 | 19.09 | 260.0 | 0.703 | 70.3% | 0.13 |
| 82FTS | 14.0 | 1.1 | 82.0 | 5.86 | 74.55 | 12.9 | 0.921 | 92.1% | 0.16 |

TABLE 3
Analysis results for Organofluorine Concentrations Before
and After Treatment - sorted by carbon chain length

| | | Raw water | Foam | | |
|---|---|---|---|---|---|
| | | concen- | concen- | Ratio of | Removal |
| | # Carbon | tration | tration | foam conc. | efficiency |
| Analyte | Atoms | (ng/L) | (ng/L) | to raw conc. | % |
| PFBS | 4 | 1,400 | 2,300 | 1.64 | 28.6% |
| PFBA | 4 | 1,300 | 1,800 | 1.38 | 23.8% |
| PFPeA | 5 | 1,400 | 1,800 | 1.29 | 33.6% |
| PFHxS | 6 | 400 | 2,800 | 7.0 | 67.5% |
| PFHxA | 6 | 3,700 | 6,700 | 1.81 | 32.4% |
| PFHpA | 7 | 640 | 3,400 | 5.31 | 59.4% |
| PFOS | 8 | 330 | 620 | 1.88 | 63.6% |
| PFOA | 8 | 970 | 8,400 | 8.66 | 78.4% |
| FOSA | 8 | 8 | 57 | 7.6 | 90.7% |
| 62FTS | 8 | 370 | 2,100 | 5.68 | 70.3% |
| PFNA | 9 | 42 | 340 | 8.1 | 89.0% |
| PFDA | 10 | 10 | 54 | 5.4 | 77.0% |
| 82FTS | 10 | 14 | 82 | 5.86 | 92.1% |
| PFUnDA | 11 | 2.3 | 4.2 | 1.83 | 47.8% |
| PFDoDA | 12 | 2.1 | 2.0 | 0.95 | 64.8% |
| PFTrDA | 13 | 2.7 | 2.0 | 0.74 | 67.8% |

TABLE 4
Analysis results for Organofluorine Concentrations Before and After
Treatment - sorted by foam concentration (data <620 ng/L omitted)

| | | Raw water | Foam | | |
|---|---|---|---|---|---|
| | | Concen- | concen- | Ratio of | Removal |
| PFC | # Carbon | tration | tration | foam conc. | efficiency |
| name | atoms | (ng/L) | (ng/L) | to raw conc. | % |
| PFOA | 8 | 970 | 8,400 | 8.65 | 78.4% |
| PFHxA | 6 | 3,700 | 6,700 | 1.8 | 32.4% |
| PFHpA | 7 | 640 | 3,400 | 5.3 | 59.4% |
| PFHxS | 6 | 400 | 2,800 | 7.0 | 67.5% |
| PFBS | 4 | 1,400 | 2,300 | 1.64 | 28.6% |
| 62FTS | 8 | 370 | 2,100 | 5.67 | 70.3% |
| PFPeA | 5 | 1,400 | 1,800 | 1.28 | 33.6% |
| PFBA | 4 | 1,300 | 1,800 | 1.38 | 23.8% |
| PFOS | 8 | 330 | 620 | 1.88 | 63.6% |

TABLE 5
Analysis results for Organofluorine Concentrations
Before and After Treatment - sorted by absolute
removal (data less than 210 ng/L omitted)

| | | | Absolute | | |
|---|---|---|---|---|---|
| | Raw water | Foam | removal | | |
| | Concen- | concen- | from | | Removal |
| PFC | tration | tration | effluent | # Carbon | efficiency |
| name | (ng/L) | (ng/L) | (ng/L) | atoms | % |
| PFHxA | 3,700 | 6,700 | 1,200 | 6 | 32.4% |
| PFOA | 970 | 8,400 | 760 | 8 | 78.4% |
| PFPeA | 1,400 | 1,800 | 470 | 5 | 33.6% |
| PFBS | 1,400 | 2,300 | 400 | 4 | 28.6% |
| PFHpA | 640 | 3,400 | 380 | 7 | 59.4% |
| PFBA | 1,300 | 1,800 | 310 | 4 | 23.8% |
| PFHxS | 400 | 2,800 | 270 | 6 | 67.5% |
| 62FTS | 370 | 2,100 | 260 | 8 | 70.3% |
| PFOS | 330 | 620 | 210 | 8 | 63.6% |

TABLE 6
Analysis results for Organofluorine Concentrations Before
and After Treatment - sorted by ratio of foam concentration
to raw concentration (data less than 1.9:1 omitted)

| | Raw water | Foam | | |
|---|---|---|---|---|
| | Concen- | concen- | Ratio of | Removal |
| | tration | tration | foam conc. | efficiency |
| Analyte | (ng/L) | (ng/L) | to raw conc. | % |
| PFOA | 970 | 8,400 | 8.7 | 78% |
| PFNA | 42 | 340 | 8.1 | 89% |
| FOSA | 7.5 | 57 | 7.6 | 90% |
| PFHxS | 400 | 2,800 | 7.0 | 67.5% |
| 82FTS | 14 | 82 | 5.9 | 92% |
| 62FTS | 370 | 2,100 | 5.7 | 70.2% |
| PFDA | 10 | 54 | 5.4 | 77% |
| PFHpA | 640 | 3,400 | 5.3 | 59% |
| PFOS | 330 | 620 | 1.9 | 63% |

### Example 2

The ammonia depleted leachate was subjected to electrochemical treatment using the apparatus of FIGS. 18-22, which has 160 electrode plates. The electrochemical treatment was performed with a cell residence time of 45 seconds, a flow rate of 11.09 kL per hour (3.08 L per second), using mild carbon steel electrodes. The distance between electrodes was 3 mm, and the voltage applied was 1.1 volts per cell (one cell is the space between two adjoining electrodes). The target current was 9 amps. Electrode polarity was controlled externally to avoid cathode passivation. The temperature of the liquid being treated was near ambient temperature (around 30-32° C.). No gases or other treatment agents were used during the electrochemical treatment.

Foam was produced during the electrochemical treatment. Without wishing to be bound by theory, it is believed that foam production was enhanced by the production of hydrogen gas at the sacrificial electrodes during the electrochemical treatment. After production, the gas became entrained with the organofluorines, producing foam. The foam settled on the surface of the liquid in the treatment chamber 210. The foam was collected using foam collector 400 and then allowed to de-gas in a separate vessel for collection.

The treated water was collected. Given the residence time and flow rate of the electrochemical treatment, floc did not settle on the base of the treatment chamber 210, and there was insufficient time for significant quantities of floc to settle on the surface of the liquid in the treatment chamber 210. Consequently, the treated water included floc. A sample of the treated liquid was collected, immediately after it filtered through the foam collector 400 (i.e. most floc would not have time to settle out).

Samples of the raw leachate, the foam, and the treated liquid were analysed by ALS, Kelso, Wash. Each sample was homogenized prior to assessment by LC MS MS MS. The results are provided in Table 7.

TABLE 7
Analysis results for Organofluorine Concentrations
Before and After Treatment - Full Data

| | | | Treated | | | |
|---|---|---|---|---|---|---|
| | | | water | | | |
| | | | (ng/L) | | | |
| | | | immediately | Ratio of | | Removal |
| | Raw water | Foam | after | foam conc. | Removal | efficiency |
| Analyte | (ng/L) | (ng/L) | filtering | to raw conc. | (ng/L) | % |
| PFBS | 1,600 | 2,000 | 1,600 | 1.25 | 0 | 0.00% |
| PFHxS | 700 | 15,000 | 630 | 21.42 | 70 | 10.00% |
| PFOS | 290 | 15,000 | 88 | 51.72 | 202 | 69.66% |
| PFBA | 1,100 | 1,500 | 1,400 | 1.36 | −300 | −27.27% |
| PFPeA | 1,700 | 2,700 | 1,800 | 1.59 | −100 | −5.88% |
| PFHxA | 3,800 | 11,000 | 5,000 | 2.89 | −1,200 | −31.58% |
| PFHpA | 880 | 8,800 | 1,000 | 10.0 | −120 | −13.64% |
| PFOA | 1,600 | 51,000 | 930 | 31.88 | 670 | 41.88% |
| PFNA | 140 | 11,000 | 56 | 78.57 | 84 | 60.00% |
| PFDA | 48 | 4,400 | 16 | 91.67 | 32 | 66.67% |
| PFUnDA | 16 | 270 | | 16.88 | 16 | 100.00% |
| PFDoDA | | 34 | | | 0 | |
| PFTrDA | | | | | 0 | |
| FOSA | | 330 | 1,400 | | −1,400 | |
| 62FTS | 710 | 21,000 | 1,400 | 29.58 | −690 | −97.18% |
| 82FTS | 66 | 17,000 | 160 | 257.58 | −94 | −142.42% |

In this example, the treated water still contained floc which had not settled. Without wishing to be bound by theory, it is believed that some of the larger long chain organofluorines degraded to a smaller short chain organofluorine. The smaller organofluorine then either remained in the supernatant liquid, or adsorbed to form part of the floc.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

### Advantages

Advantages of a preferred embodiment of the present invention may include:
The electrochemical process is engineered to rely on relatively low cost and freely available anode compositions compared to the examples in the scientific literature;
The process is fast and scalable to commercial treatment rates unlike batch processes requiring 2-10 hours of treatment time;
The treated effluent from the process is then directed (as required) to a sorptive process if needed for final polishing;
The process is engineered so that the surfactant form of the PFC, PFOA and PFOS decay products is regenerated in the cell so that the surfactant segregates to the liquid-gas interface;
The electrochemical process is engineered to also produce quantities of reductant, inert, or oxidative gases to facilitate the phase separation of PFCs and resulting PFOA and PFOS degradation products to the foam with the surfactant then separated by foam fractionation;
The foam, selectively enhanced to carry the bulk of the PFC, PFOA and PFOS is collected by either a dissolved air flotation (DAF) type skimmer following adsorption onto sacrificial anode (cell generated) ferrous or ferric hydroxide sludge for either encapsulation, disposal or secure landfill;
The foam, carrying the bulk of the PFC, PFOA and PFOS is collected by suction producing a concentrated liquid phase requiring disposal;
Since cell residence times as low as 60 seconds (1 minute) can achieve the phase change required to separate the organofluorines and degradation products from the water columns, this enables much more cost effective adsorption onto a filtering media suitable for environmentally sensitive disposal; and
A fast and efficient water treatment process typically of less than 60-120 seconds residence time to avoid 2-10 hour (120-600 minute) cell residence times required of many competing technologies.

1. A method of treating a liquid including an organofluorine, the method comprising:
electrochemically treating the liquid to thereby produce foam and an electrochemically treated liquid, wherein the foam includes the organofluorine and/or degradation products thereof; and
separating the foam from the electrochemically treated liquid.

2. The method of claim 1, wherein at least 60% of the carbon atoms in the organofluorine are substituted by a fluorine atom.

3. The method of claim 1, wherein the organofluorine is of the formula (I):
R—Y Formula I
wherein R is a fluoroalkyl group, and Y is an ionic group.

4. The method of claim 1, wherein the liquid is a groundwater, a landfill leachate or an industrial waste.

5. The method of claim 1, wherein the method includes the step of removing or depleting ammonia or ammonium from the liquid prior to the electrochemical treatment.

6. The method of claim 5, wherein the step of removing or depleting ammonia or ammonium from the liquid prior to the electrochemical treatment includes adding a magnesium salt and a phosphate salt to the liquid to form a precipitate.

7. The method of claim 1, wherein the method includes the step of filtering the liquid prior to the electrochemical treatment.

8. The method of claim 1, wherein the method further includes the step of adding a treatment agent to the liquid.

9. The method of claim 8, wherein the treatment agent is an alkaline earth metal.

10. The method of claim 1, wherein the step of electrochemically treating the liquid is performed using an electrochemical treatment apparatus, wherein the electrochemical treatment apparatus includes a treatment chamber including at least one inlet for entry of a liquid to be treated, and at least one outlet for exit of electrochemically treated liquid, and a plurality of electrodes positioned within the treatment chamber for electrochemical treatment of the liquid.

11. The method of claim 10, wherein at least one of the plurality of electrodes positioned within the treatment chamber include iron.

12. The method of claim 10, wherein there is substantially laminar flow of liquid between the electrodes during electrochemical treatment.

13. The method of claim 10, wherein the method includes the step of collecting the separated foam using a foam collector located in fluid connection with the at least one outlet for exit of electrochemically treated liquid; wherein the foam collector includes a mesh filter and a suction source.

14. The method of claim 1, wherein the method includes the step of treating the separated foam.

15. The method of claim 14, wherein the step of treating the separated foam includes degassing the foam or incinerating the foam.

16. The method of claim 15, wherein degassing the foam includes placing the foam under reduced pressure, or by spraying liquid onto the foam.
